(19) United States
(12) Patent Application Publication
(10) Pub. No.: US 2026/0184068 A1
(43) Pub. Date: Jul. 2, 2026

(54) LIQUID EJECTING HEAD AND LIQUID EJECTING APPARATUS

(71) Applicant: SEIKO EPSON CORPORATION, Tokyo (JP)

(72) Inventors: Shuichi KOGANEHIRA, Matsumoto (JP); Keisuke NISHIDA, Shiojiri (JP); Shun KATSUIE, Matsumoto (JP); Masako TANAKA, Shiojiri (JP)

(21) Appl. No.: 19/430,637

(22) Filed: Dec. 23, 2025

(30) Foreign Application Priority Data
Dec. 26, 2024 (JP) 2024-230461

(51) Int. Cl. B41J 2/045; B41J 2/14; B41J 2/16; B41J 2/165

(52) U.S. Cl. CPC B41J 2/0451; B41J 2/14201; B41J 2/1623; B41J 2/16579; B41J 2/04581; B41J 2002/14403; B41J 2002/14419; B41J 2202/19

(57) ABSTRACT

A liquid ejecting head includes: a flow path that communicates with a nozzle that ejects liquid; an accommodating space; a first bonding portion that partitions the flow path from the accommodating space; and an outflow material that is accommodated in the accommodating space and that flows out into the flow path when the first bonding portion no longer partitions the flow path from the accommodating space.

The present application is based on, and claims priority from JP Application Serial Number 2024-230461, filed Dec. 26, 2024, the disclosure of which is hereby incorporated by reference herein in its entirety.

### BACKGROUND

### 1. Technical Field

The present disclosure relates to a liquid ejecting head and a liquid ejecting apparatus.
2. Related Art

In the related art, a liquid ejecting head that ejects liquid such as ink from a nozzle is widely used. For example, JP-A-2023-100338 discloses that a plurality of flow path members constituting a flow path of a liquid ejecting head are joined to each other with an adhesive, thereby liquid-tightly coupling flow paths formed in the plurality of joined flow path members.

The adhesive joining the flow path members deteriorates upon contact with liquid flowing through the flow path, and the liquid in the flow path may leak out from a bonded portion to an outside of the flow path members. However, in the related art mentioned above, there is a problem in that a user of the liquid ejecting head cannot determine when the liquid ejecting head should be replaced.

### SUMMARY

According to a preferred aspect of the present disclosure, there is provided a liquid ejecting head including: a flow path that communicates with a nozzle that ejects liquid; an accommodating space; a first bonding portion that partitions the flow path from the accommodating space; and an outflow material that is accommodated in the accommodating space and that flows out into the flow path when the first bonding portion no longer partitions the flow path from the accommodating space.

According to a preferred aspect of the present disclosure, there is provided a liquid ejecting head including: a flow path that communicates with a nozzle that ejects liquid; and a third bonding portion disposed in the flow path, in which the third bonding portion contains an outflow material that flows out into the flow path when the third bonding portion is eluted into liquid in the flow path.

According to a preferred aspect of the present disclosure, there is provided a liquid ejecting apparatus including: the liquid ejecting head including a first flow path member that constitutes a first flow path, which is a part of the flow path, a second flow path member that constitutes a second flow path, which is a part of the flow path, and a second bonding portion that bonds the first flow path member and the second flow path member such that the first flow path and the second flow path are in liquid-tight communication; an acquisition section that acquires information regarding whether or not the filter is clogged with the outflow material; and an estimation section that estimates a degree of deterioration of the second bonding portion based on the information acquired by the acquisition section.

According to a preferred aspect of the present disclosure, there is provided a liquid ejecting apparatus including: the liquid ejecting head including a first flow path member that constitutes a first flow path, which is a part of the flow path, a second flow path member that constitutes a second flow path, which is a part of the flow path, and a second bonding portion that bonds the first flow path member and the second flow path member such that the first flow path and the second flow path are in liquid-tight communication; an acquisition section that acquires information regarding whether or not a color of liquid flowing in the flow path is abnormal; and an estimation section that estimates a degree of deterioration of the second bonding portion based on the information acquired by the acquisition section.

### BRIEF DESCRIPTION OF THE DRAWINGS

FIG. 1 is a schematic diagram showing a configuration example of an ink jet system according to a first embodiment.

FIG. 2 is a diagram showing a configuration of a processing apparatus.

FIG. 3 is a block diagram showing a configuration example of an ink jet printer.

FIG. 4 is a configuration diagram of the ink jet printer.

FIG. 5 is an exploded perspective view of a liquid ejecting head.

FIG. 6 is a cross-sectional view of the liquid ejecting head taken along line VI-VI in FIG. 5.

FIG. 7 is an enlarged view of a vicinity of an ink hole shown in FIG. 6.

FIG. 8 is a cross-sectional view of a head unit taken along an X-axis direction through a wiring hole.

FIG. 9 is a plan view schematically showing an inside of the head unit.

FIG. 10 is a plan view exemplifying an in-structure flow path.

FIG. 11 is a side view of an in-structure supply flow path and an in-structure discharge flow path of the in-structure flow path, through which a first ink flows.

FIG. 12 is a side view of an in-structure supply flow path and an in-structure discharge flow path of the in-structure flow path, through which a second ink flows.

FIG. 13 is a view illustrating an accommodating space and an outflow material.

FIG. 14 is a diagram showing a function of an ink jet system.

FIG. 15 is a diagram showing a flowchart showing an operation of the ink jet system.

FIG. 16 is a block diagram showing a configuration example of an ink jet printer in a second embodiment.

FIG. 17 is a diagram showing a flowchart showing an operation of an ink jet system in the second embodiment.

FIG. 18 is a block diagram showing a configuration example of an ink jet printer in a third embodiment.

FIG. 19 is a view illustrating an outflow material-containing bonding portion.

FIG. 20 is a view illustrating an outflow material-containing bonding portion in a first modification example.

FIG. 21 is a block diagram showing a configuration example of an ink jet printer in a second modification example.

FIG. 22 is a view illustrating an outflow material-containing bonding portion.

FIG. 23 is a view illustrating an accommodating space in a third modification example.

### DESCRIPTION OF EMBODIMENTS

Hereinafter, embodiments for implementing the present disclosure will be described with reference to the drawings. Note that, in the drawings, dimensions and scales of each portion are made different from actual ones as appropriate. In addition, since embodiments to be described below are preferred specific examples of the present disclosure, various technically preferable limitations are imposed. However, the scope of the present disclosure is not limited to these embodiments unless there is a description in the following description that particularly limits the present disclosure.

Hereinafter, for convenience of description, one direction along an X-axis from any point will be referred to as an X1 direction, and a direction opposite to the X1 direction will be referred to as an X2 direction. The X1 direction and the X2 direction are collectively referred to as a direction along the X-axis. Similarly, directions opposite to each other along a Y-axis from any point will be referred to as a Y1 direction and a Y2 direction, and directions opposite to each other along a Z-axis from any point will be referred to as a Z1 direction and a Z2 direction. The Y1 direction and the Y2 direction are collectively referred to as a direction along the Y-axis. The Z1 direction and the Z2 direction are collectively referred to as a direction along the Z-axis. The direction along the X-axis and the direction along the Y-axis are orthogonal to each other. The direction along the X-axis and the direction along the Z-axis are orthogonal to each other. The direction along the Y-axis and the direction along the Z-axis are orthogonal to each other. An X-Y plane including the X-axis and the Y-axis corresponds to a horizontal plane. The Z-axis is an axis along a vertical direction, the Z1 direction corresponds to an upper side in the vertical direction, and the Z2 direction corresponds to a lower side in the vertical direction. Additionally, viewing in the direction along the Z-axis may be referred to as “plan view”.

### 1. First Embodiment

### 1-1. Overview of Ink Jet System SYS

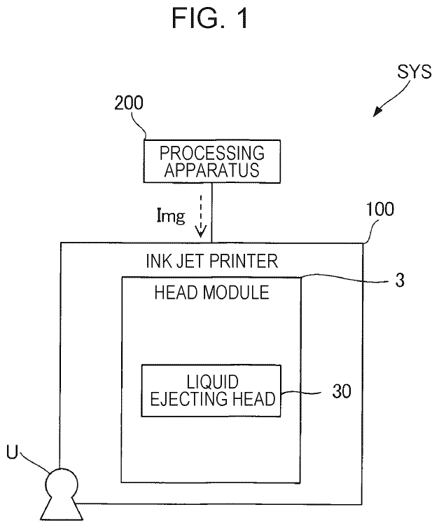

FIG. 1 is a schematic diagram showing a configuration example of an ink jet system SYS according to a first embodiment. The ink jet system SYS is a system that provides a service of forming an image on a medium PP, which will be described below, by using an ink jet method. The ink jet system SYS includes an ink jet printer 100 and a processing apparatus 200.

Here, the ink jet printer 100 is an apparatus provided by a manufacturer of the ink jet printer 100. The ink jet printer 100 is a liquid ejecting apparatus that ejects ink, which is an example of liquid. The manufacturer of the ink jet printer 100 is a company that manufactures the ink jet printer 100. The manufacturer of the ink jet printer 100 may be referred to as a “printer manufacturer”. A liquid ejecting head 30 incorporated into the ink jet printer 100 is provided by a manufacturer of the liquid ejecting head 30. The manufacturer of the liquid ejecting head 30 is a company that manufactures the liquid ejecting head 30. Hereinafter, the manufacturer of the liquid ejecting head 30 may be referred to as a “head manufacturer”. The printer manufacturer receives provision of the liquid ejecting head 30 from the head manufacturer and manufactures the ink jet printer 100 by incorporating the provided liquid ejecting head 30 into the ink jet printer 100. The ink jet printer 100 is an example of a “liquid ejecting apparatus”.

FIG. 1 shows a user U who uses the ink jet printer 100. As the user U, for example, when an operator belonging to the printer manufacturer uses the ink jet printer 100, this operator is the user U. In addition, for example, when a third party who receives the provision of the ink jet printer 100 from the printer manufacturer uses the ink jet printer 100, this third party is the user U. The user U uses the processing apparatus 200 in addition to the ink jet printer 100.

The ink jet printer 100 receives image data Img indicating an image from the processing apparatus 200. The ink jet printer 100 forms an image based on the image data Img on the medium PP. Hereinafter, a process of forming an image on the medium PP may be referred to as a “printing process”.

The ink jet printer 100 includes one head module 3 including one liquid ejecting head 30.

The processing apparatus 200 is a computer such as a desktop type or a notebook type. The processing apparatus 200 may be provided as a part of the ink jet printer 100.

### 1-2. Concerning Failure of Liquid Ejecting Head 30

The liquid ejecting head 30 provided in the ink jet printer 100 may fail because of aging deterioration or the like. One reason for failure of the liquid ejecting head 30 is that a bonding portion that bonds two flow path members constituting a flow path in the liquid ejecting head 30 to liquid-tightly couple flow paths of the two flow path members may come into contact with ink for a long period of time, thereby undergoing either or both of deterioration due to wear caused by a flow velocity or the like and deterioration due to elution of an adhesive into the ink caused by attack by the ink. Consequently, the flow paths of the two flow path members cannot be liquid-tightly coupled, and ink may leak out of the flow path from a location where liquid-tight coupling is no longer possible. Hereinafter, a case where the adhesive can no longer seal a gap between the flow paths of the two flow path members may be referred to as “seal failure”. When seal failure occurs, ink may leak out of the flow path from a location where the seal failure occurs. When ink leaks out of the flow path, the ink may adhere to an electronic circuit in the liquid ejecting head 30 to cause failure, or an inside or a periphery of the ink jet printer 100 may become contaminated with the ink.

Accordingly, there is provided a liquid ejecting head 30 capable of detecting a sign of ink leakage from the liquid ejecting head 30, before the liquid ejecting head 30 fails because of ink leaking out of the flow path from the location where seal failure occurs. The sign of ink leakage from the liquid ejecting head 30 includes that ink will soon leak from the liquid ejecting head 30, and estimation of a lifetime of the liquid ejecting head 30, that is, estimation of a time point at which ink will leak from the liquid ejecting head 30.

### 1-3. Configuration of Processing Apparatus 200

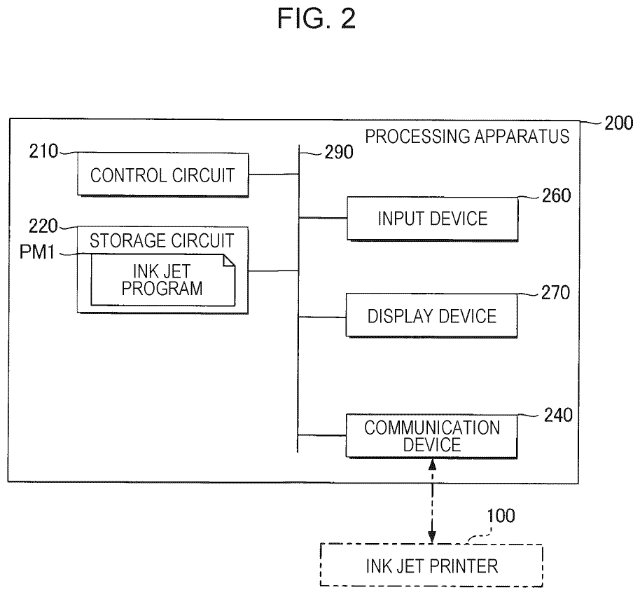

FIG. 2 is a diagram showing a configuration of the processing apparatus 200. The processing apparatus 200 includes a control circuit 210, a storage circuit 220, a communication device 240, an input device 260, and a display device 270. The control circuit 210, the storage circuit 220, the communication device 240, the input device 260, and the display device 270 are mutually connected by a bus 290 for information communication.

The control circuit 210 includes, for example, one or more processors such as a central processing unit (CPU). The control circuit 210 may include a programmable logic device such as a field-programmable gate array (FPGA) instead of the CPU or in addition to the CPU.

The storage circuit 220 is configured with a magnetic storage device, a flash ROM, or the like. The storage circuit 220 is readable by the control circuit 210 and stores a plurality of programs including an ink jet program PM1 executed by the control circuit 210, various kinds of information used by the control circuit 210, and the like. The storage circuit 220 includes, for example, semiconductor memories of one or both of one or more volatile memories, such as a RAM, and one or more non-volatile memories, such as a ROM, an EEPROM, or a PROM. The ink jet program PM1 is, for example, a program for generating the image data Img.

The communication device 240 is a circuit that can communicate with the ink jet printer 100. For example, the communication device 240 is a network card, such as a Universal Serial Bus (USB) or Bluetooth. USB and Bluetooth are registered trademarks.

The input device 260 is a device that outputs operation information corresponding to an operation of the user U. The input device 260 is, for example, a mouse and a keyboard.

The display device 270 displays an image indicating some kind of information to the user U. The display device 270 is an organic electro-luminescence (EL) display, a light emitting diode (LED) display, and a liquid crystal display (LCD). Additionally, the input device 260 and the display device 270 may be configured integrally. A configuration in which the input device 260 and the display device 270 are integral is, for example, a touch panel.

### 1-4. Overview of Ink Jet Printer 100

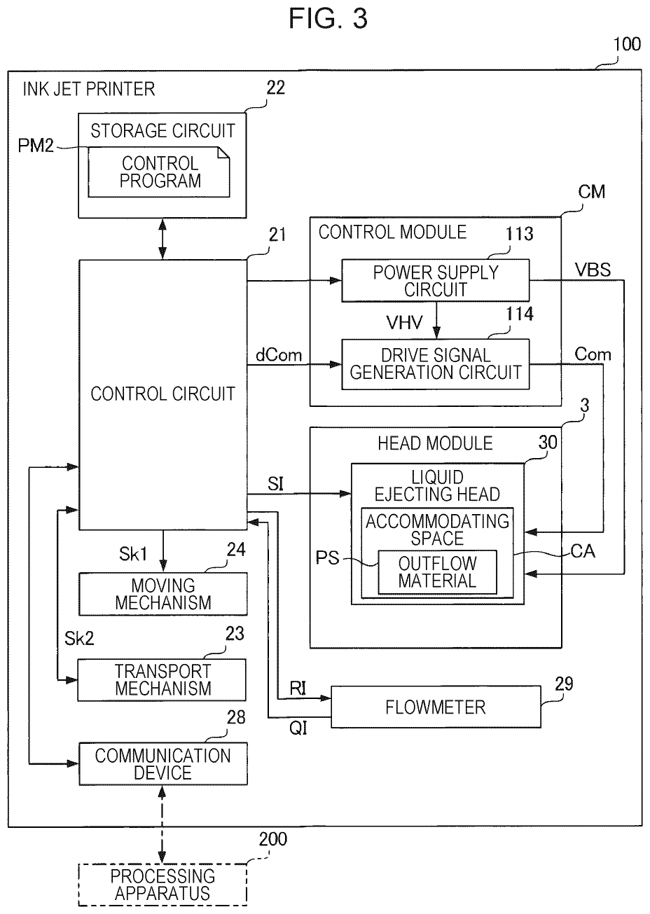

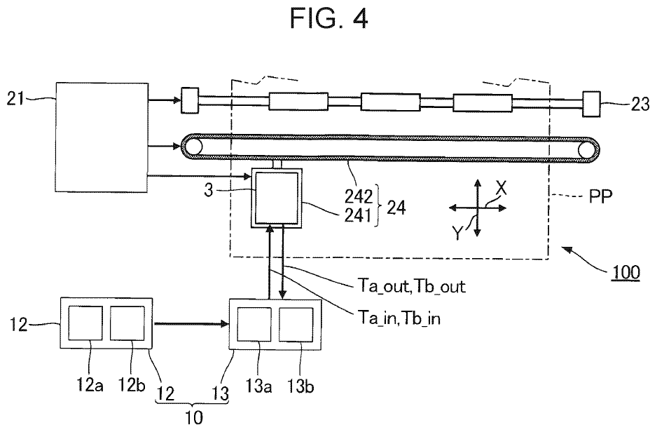

FIG. 3 is a block diagram showing a configuration example of the ink jet printer 100. FIG. 4 is a configuration diagram of the ink jet printer 100. The ink jet printer 100 shown in FIG. 4 is an ink jet type printing apparatus that ejects ink as droplets onto the medium PP. The ink is an example of “liquid”. The medium PP is, for example, printing paper. However, the medium PP is not limited to printing paper and may be, for example, a printing target of any material, such as a resin film or fabric.

As shown in FIGS. 3 and 4, the ink jet printer 100 includes a control module CM, a liquid supply system 10, a control circuit 21, a storage circuit 22, a transport mechanism 23, a moving mechanism 24, the head module 3, a communication device 28, and a flowmeter 29.

The control module CM includes a power supply circuit 113 and a drive signal generation circuit 114. The power supply circuit 113 receives supply of electric power from a commercial power source (not shown) and generates various predetermined potentials. The various generated potentials are supplied to each portion of the ink jet printer 100 as appropriate. In the example shown in FIG. 3, the power supply circuit 113 generates a power supply potential VHV and an offset potential VBS. The offset potential VBS is supplied to the liquid ejecting head 30. Additionally, the power supply potential VHV is supplied to the drive signal generation circuit 114 and the like.

The drive signal generation circuit 114 is a circuit that generates a drive signal Com for driving the liquid ejecting head 30. Specifically, the drive signal generation circuit 114 includes, for example, a DA conversion circuit and an amplification circuit. In the drive signal generation circuit 114, the DA conversion circuit converts a waveform designation signal dCom, which will be described below, from the control circuit 21 from a digital signal into an analog signal, and the amplification circuit generates the drive signal Com by amplifying the analog signal using the power supply potential VHV from the power supply circuit 113.

The liquid supply system 10 includes a liquid container 12 and a sub tank 13. The liquid container 12 stores ink. The sub tank 13 temporarily stores ink supplied from the liquid container 12.

The liquid container 12 includes, for example, a cartridge that is attachable to and detachable from the ink jet printer 100, a bag-shaped ink pack formed of a flexible film, or an ink tank capable of being refilled with ink. The liquid container 12 includes liquid containers 12a and 12b. For example, different color inks are stored in the liquid containers 12a and 12b. A first ink is stored in the liquid container 12a. For example, a second ink having a color different from that of the first ink is stored in the liquid container 12b.

The sub tank 13 includes sub tanks 13a and 13b. The sub tank 13a is coupled to the liquid container 12a and temporarily stores the first ink. The sub tank 13b is coupled to the liquid container 12b and temporarily stores the second ink. In addition, a supply tube Ta_in and a discharge tube Ta_out are coupled to the sub tank 13a. A supply tube Tb_in and a discharge tube Tb_out are coupled to the sub tank 13b. These tubes are coupled to the head module 3. Such a sub tank 13 supplies ink to the head module 3 and collects ink from the head module 3. Accordingly, ink circulates between the sub tank 13 and the head module 3.

The ink is, for example, an aqueous pigment ink, a solvent ink, or an ultraviolet curable ink. The solvent ink is an ink containing an organic solvent. The solvent ink is an ink in which, after being applied to the medium PP, the organic solvent penetrates into the medium PP to form a receiving layer, and a color material is fixed on the receiving layer. The ultraviolet curable ink is an ink containing an ultraviolet curable component. Hereinafter, the ultraviolet curable ink will be referred to as an ultraviolet (UV) ink. The ultraviolet curable component contains a monomer or an oligomer. The UV ink is ink in which, after being applied to the medium PP, the ultraviolet curable component is cured by irradiation with ultraviolet rays, and a color material is fixed in a coating formed by curing of the ultraviolet curable component.

The storage circuit 22 stores various programs including a control program PM2 executed by the control circuit 21 and various kinds of data such as the image data Img processed by the control circuit 21. The storage circuit 22 includes, for example, semiconductor memories of one or both of one or more volatile memories, such as a RAM, and one or more non-volatile memories, such as a ROM, an EEPROM, or a PROM. The storage circuit 22 may be configured as a part of the control circuit 21.

The transport mechanism 23 transports the medium PP along the Y-axis under the control of the control circuit 21. The moving mechanism 24 reciprocates the head module 3 along the X-axis under the control of the control circuit 21.

The moving mechanism 24 includes a substantially box-shaped support 241 that accommodates the head module 3, and an endless belt 242 to which the support 241 is fixed.

The communication device 28 is a circuit that can communicate with the processing apparatus 200. For example, the communication device 28 is a network card, such as USB or Bluetooth. In addition, the communication device 28 may be integrated with the control circuit 21.

The head module 3 ejects ink supplied from the sub tank 13 onto the medium PP under the control of the control circuit 21. By ejecting ink from the head module 3 onto the medium PP in parallel with transport of the medium PP by the transport mechanism 23 and repetitive reciprocation of the support 241, an image is formed on a surface of the medium PP. Ink not ejected from the head module 3 is discharged to the sub tank 13. The head module 3 includes one liquid ejecting head 30, but may include a plurality of liquid ejecting heads 30.

The description returns to FIGS. 3 and 4. The control circuit 21 controls each element provided in the ink jet printer 100. The control circuit 21 includes, for example, one or more of processing circuits, such as a CPU or an FPGA, and one or more of storage circuits, such as a semiconductor memory.

The control circuit 21 controls the operation of each portion of the ink jet printer 100 by executing a program stored in the storage circuit 22. Here, the control circuit 21 generates signals such as a control signal Sk1, a control signal Sk2, a print signal SI, a waveform designation signal dCom, and a request signal RI as signals for controlling the operation of each portion of the ink jet printer 100.

The control signal Sk1 is a signal for controlling driving of the moving mechanism 24. The control signal Sk2 is a signal for controlling driving of the transport mechanism 23. The print signal SI is a signal for controlling driving of the liquid ejecting head 30. The waveform designation signal dCom is a digital signal for defining a waveform of the drive signal Com generated by the drive signal generation circuit 114.

The flowmeter 29 measures a flow rate value of the flow path in the liquid ejecting head 30. For example, the flowmeter 29 is provided in the middle of the supply tube Ta_in or in the middle of the discharge tube Ta_out. In addition, in the example of FIG. 3, the flowmeter 29 is provided outside the liquid ejecting head 30, but the flowmeter 29 may be provided inside the liquid ejecting head 30. When the flowmeter 29 receives the request signal RI from the control circuit 21, the flowmeter 29 generates flow rate information QI indicating the measured flow rate value and transmits the flow rate information QI to the control circuit 21.

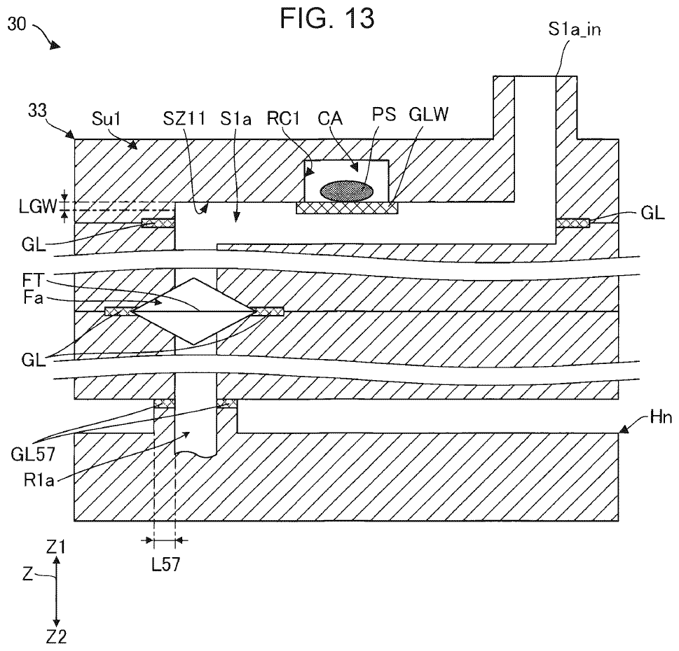

The liquid ejecting head 30 is provided with an accommodating space CA used to detect a sign of ink leakage from the liquid ejecting head 30. An outflow material PS is accommodated in the accommodating space CA. The accommodating space CA and the outflow material PS will be described with reference to FIG. 13.

### 1-5. Overall Configuration of Liquid Ejecting Head 30

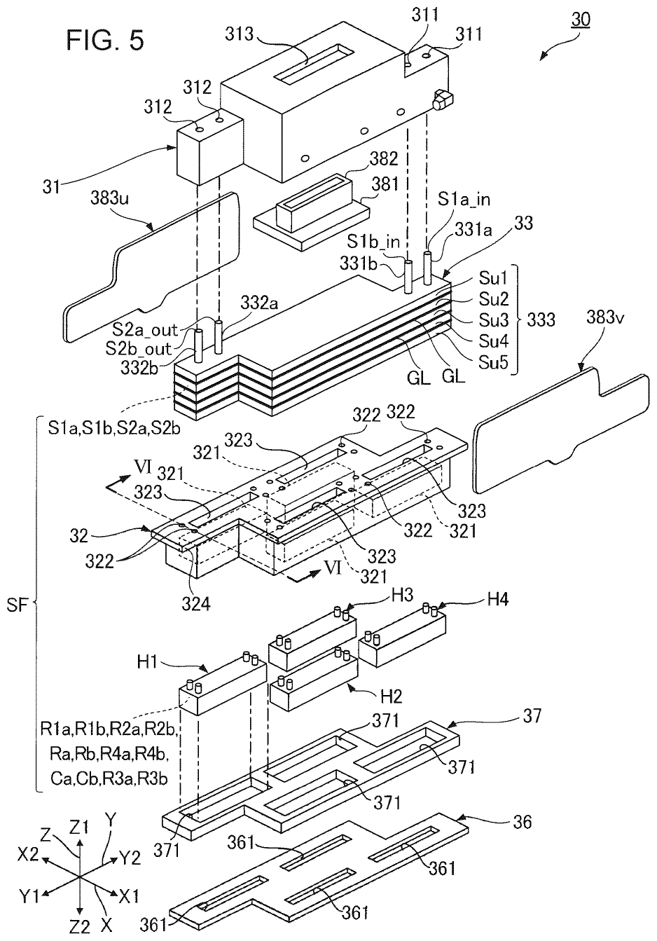

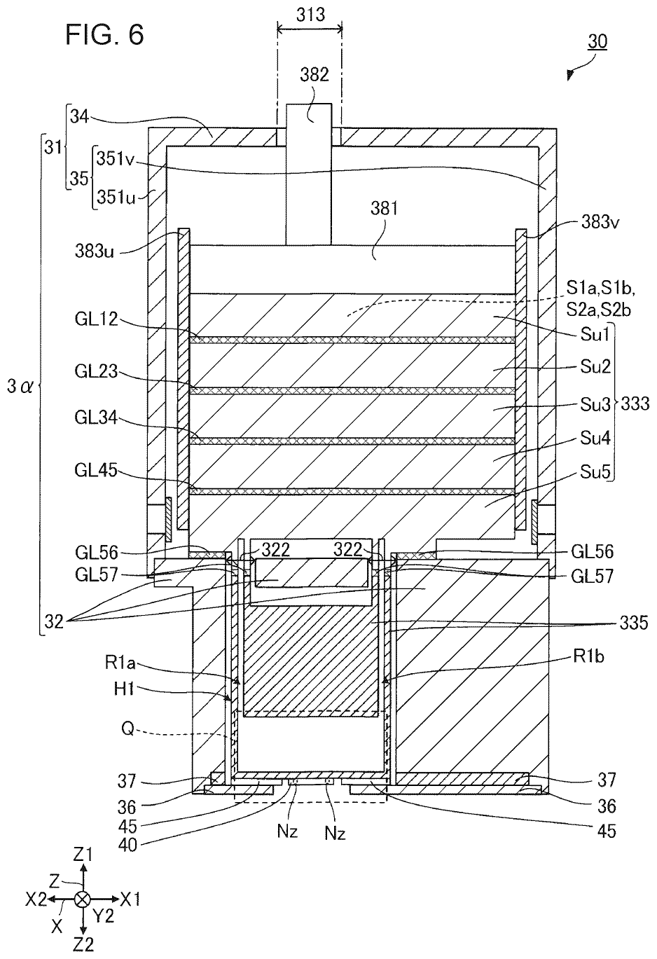

FIG. 5 is an exploded perspective view of the liquid ejecting head 30. FIG. 6 is a cross-sectional view of the liquid ejecting head 30 taken along line VI-VI in FIG. 5. The view shown in FIG. 6 is a view of a cross-section of the liquid ejecting head 30 taken along line VI-VI as viewed in the Y2 direction. The line VI-VI is an imaginary line segment passing through two ink holes 322 and along the X-axis direction.

As shown in FIG. 5, the liquid ejecting head 30 includes a housing 3α, a flow path structure 33, a fixing plate 36, and a reinforcing plate 37. Additionally, the liquid ejecting head 30 includes a plurality of head units H1, H2, H3, and H4. The head units H1, H2, H3, and H4 are referred to as a head unit Hn unless otherwise distinguished. In addition, the liquid ejecting head 30 includes electrical elements such as a wiring substrate 381, a wiring member 382, and circuit boards 383u and 383v. Further, the flow path structure 33 includes a laminate 333, supply coupling portions 331a and 331b, and discharge coupling portions 332a and 332b. Hereinafter, each element provided in the liquid ejecting head 30 will be described with reference to FIGS. 5 and 6.

The housing 3α shown in FIGS. 5 and 6 is a hollow case that accommodates the head unit Hn and the laminate 333. The housing 3α includes a cover member 31 and a holder member 32.

The cover member 31 accommodates the laminate 333. The holder member 32 accommodates the plurality of head units Hn. In the present embodiment, the holder member 32 accommodates four head units Hn. The holder member 32 is disposed in the Z2 direction with respect to the cover member 31.

As shown in FIG. 5, the cover member 31 includes two first coupling portion holes 311, two second coupling portion holes 312, and a first hole 313. The first hole 313 is a hole through which the wiring member 382 is inserted. One of the supply coupling portions 331a and 331b is inserted through and fitted into each first coupling portion hole 311. One of the discharge coupling portions 332a and 332b is inserted through and fitted into each second coupling portion hole 312.

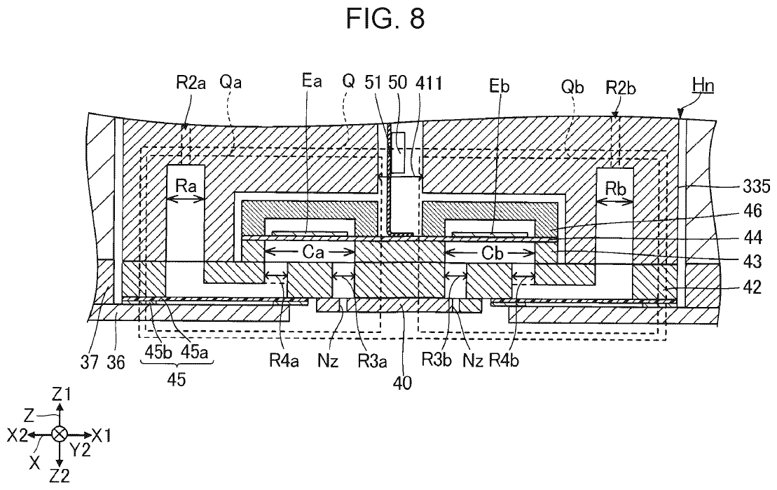

The holder member 32 includes a plurality of recessed portions 321, a plurality of ink holes 322, and a plurality of wiring holes 323. Each recessed portion 321 is a depression that is open in the Z2 direction. The head unit Hn is disposed in each recessed portion 321. Each ink hole 322 is a hole through which ink flows between the flow path structure 33 and the head unit Hn. Each wiring hole 323 communicates with the recessed portion 321. Each wiring hole 323 is a hole through which a flexible substrate 51 shown in FIG. 8 is passed. The flexible substrate 51 is provided for each head unit Hn and is electrically coupled to the head unit Hn. In addition, as shown in FIG. 5, the holder member 32 includes a flange 324 for fixing the holder member 32 to the support 241.

As shown in FIG. 6, the housing 3α includes an upper wall portion 34 and a side wall portion 35. The side wall portion 35 includes a side wall 351u and a side wall 351v.

As shown in FIG. 5, the laminate 333 of the flow path structure 33 includes a plurality of flow path plates Su1, Su2, Su3, Su4, and Su5, and the plurality of flow path plates Su1, Su2, Su3, Su4, and Su5 are referred to as a flow path plate Su unless otherwise distinguished. Each flow path plate Su is formed by, for example, injection molding of a resin, but may also be formed of a metal.

The flow path plates Su1 to Su5 are bonded to each other by an adhesive that forms bonding portions GL12, GL23, GL34, and GL45. The flow path plate Su5 is bonded in the Z1 direction to the holder member 32 by an adhesive that forms a bonding portion GL56. In the following description, a layer formed by an adhesive in the liquid ejecting head 30 is collectively referred to as a bonding portion GL. The bonding portion GL liquid-tightly couples two members. An adhesive forming the bonding portion GL is, for example, an epoxy-based adhesive containing an epoxy resin as a main component, but may also be a silicone-based adhesive or the like.

The liquid ejecting head 30 includes a flow path SF communicating with the nozzle Nz inside. The flow path SF includes in-structure supply flow paths S1a and S1b, in-structure discharge flow paths S2a and S2b, in-head supply flow paths R1a and R1b, in-head discharge flow paths R2a and R2b, a first liquid storage chamber Ra, a second liquid storage chamber Rb, second communication flow paths R4a and R4b, pressure chambers Ca and Cb, and first communication flow paths R3a and R3b. The bonding portion GL in contact with the ink is used as a seal of the flow path SF.

The laminate 333 includes the in-structure supply flow paths S1a and S1b and the in-structure discharge flow paths S2a and S2b. The in-structure supply flow paths S1a and S1b and the in-structure discharge flow paths S2a and S2b are referred to as an in-structure flow path Sn unless otherwise distinguished. Each in-structure flow path Sn is a space formed in the laminate 333. The ink flows through the in-structure flow path Sn. Each in-structure flow path Sn is formed by one or both of grooves along an XY plane provided in each of two flow path plates Su adjacent to each other, and a hole in the flow path plate Su that extends in the Z-axis direction. In FIG. 6, the in-structure flow path Sn is not shown in order to prevent the drawing from being complicated.

Specifically, the in-structure supply flow path S1a supplies the first ink stored in the sub tank 13a to the plurality of head units Hn. The in-structure supply flow path S1b supplies the second ink stored in the sub tank 13b to the plurality of head units Hn. The in-structure discharge flow path S2a discharges the first ink that is not ejected from the plurality of head units Hn to the sub tank 13a. The in-structure discharge flow path S2b discharges the second ink that is not ejected from the plurality of head units Hn to the sub tank 13b. Filter chambers Fa and Fb each including a filter FT that captures foreign matter or bubbles mixed into ink may be installed in the in-structure flow paths Sn.

Each of the supply coupling portions 331a and 331b and the discharge coupling portions 332a and 332b is provided in the Z1 direction with respect to the laminate 333 and protrudes from the laminate 333 in the Z1 direction. Each of the supply coupling portions 331a and 331b and the discharge coupling portions 332a and 332b is a coupling tube for communication between each in-structure flow path Sn and the outside of the housing 3α.

Specifically, the supply coupling portion 331a is a supply tube through which the first ink is supplied from the sub tank 13a to the in-structure supply flow path S1a, and is provided with a supply port S1a_in for supplying the first ink to the laminate 333. The supply coupling portion 331b is a supply tube through which the second ink is supplied from the sub tank 13b to the in-structure supply flow path S1b, and is provided with a supply port S1b_in for supplying the second ink to the laminate 333. The discharge coupling portion 332a is a discharge tube through which the first ink is discharged from the in-structure discharge flow path S2a to the sub tank 13a, and is provided with a discharge port S2a_out for discharging the first ink from the laminate 333. The discharge coupling portion 332b is a discharge tube through which the second ink is discharged from the in-structure discharge flow path S2b to the sub tank 13b, and is provided with a discharge port S2b_out for discharging the second ink from the laminate 333.

The head unit Hn includes the in-head supply flow paths R1a and R1b, the in-head discharge flow paths R2a and R2b, and a liquid ejecting portion Q that ejects ink. The first liquid storage chamber Ra, the second liquid storage chamber Rb, the second communication flow paths R4a and R4b, the pressure chambers Ca and Cb, and the first communication flow paths R3a and R3b are provided in the liquid ejecting portion Q. The flow paths provided in the liquid ejecting portion Q are shown in FIG. 8.

In FIG. 6, the detailed shape of the liquid ejecting portion Q is not shown in order to prevent the drawing from being complicated. The detailed shape of the liquid ejecting portion Q will be described below with reference to FIG. 8. As shown in FIG. 6, each head unit Hn includes a plurality of nozzles Nz. Each nozzle Nz is a through-hole for ejecting ink in the Z2 direction. Specifically, each head unit Hn includes a plurality of nozzles Nz that eject the first ink and a plurality of nozzles Nz that eject the second ink. Additionally, each head unit Hn defines the in-head supply flow paths R1a and R1b and the in-head discharge flow paths R2a and R2b.

The in-head supply flow paths R1a and R1b are flow paths from an end portion of the head unit Hn in the Z1 direction to the liquid ejecting portion Q. The in-head discharge flow paths R2a and R2b are flow paths from the liquid ejecting portion Q to the end portion of the head unit Hn in the Z1 direction. The in-head supply flow paths R1a and R1b and the in-head discharge flow paths R2a and R2b are referred to as an in-head flow path Rn unless otherwise distinguished.

The head unit Hn includes a case 335 that defines the in-head flow path Rn.

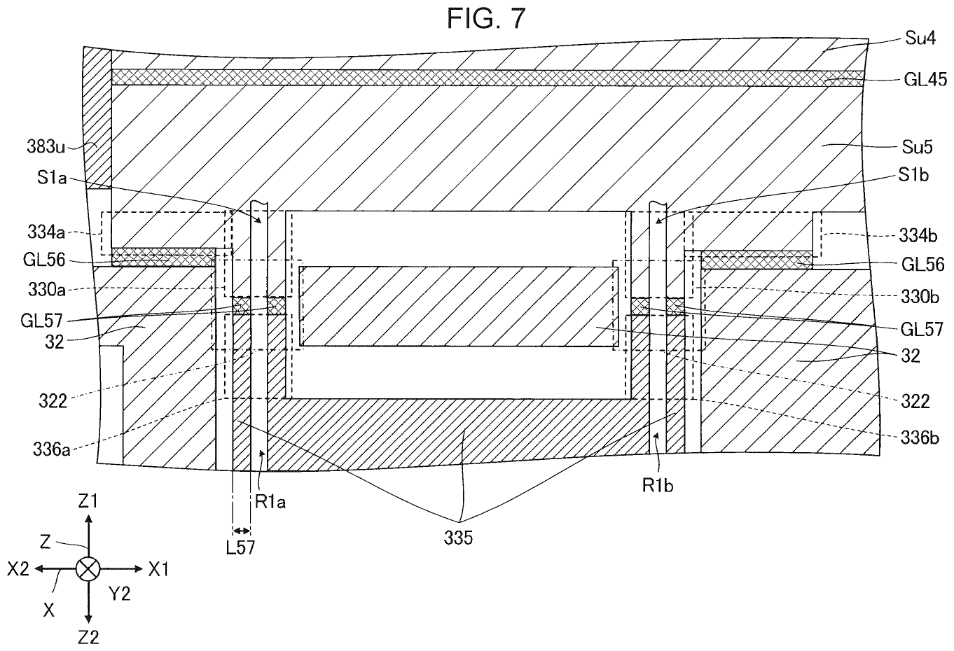

FIG. 7 is an enlarged view of a vicinity of the ink hole 322 shown in FIG. 6. The flow path plate Su5 includes columnar projecting portions 334a and 334b protruding in the Z2 direction. The projecting portions 334a and 334b are bonded in the Z1 direction to the holder member 32 by an adhesive forming the bonding portion GL56.

The flow path plate Su5 includes flow path plate side communication tubes 330a and 330b. The flow path plate side communication tubes 330a and 330b are collectively referred to as a flow path plate side communication tube 330. The flow path plate side communication tube 330 protrudes from the flow path plate Su5 toward the case 335 and is inserted through the ink hole 322.

The case 335 includes case side communication tubes 336a and 336b. The case side communication tubes 336a and 336b are collectively referred to as a case side communication tube 336. The case side communication tube 336 protrudes from the case 335 toward the flow path plate Su5 and is inserted through the ink hole 322.

An adhesive forming a bonding portion GL57 is applied to a top surface of the flow path plate side communication tube 330 and a top surface of the case side communication tube 336.

A flow direction of ink in the in-head supply flow paths R1a and R1b is the Z2 direction. The top surface of the flow path plate side communication tube 330 and the top surface of the case side communication tube 336 are perpendicular to the flow direction of ink.

The description returns to FIGS. 5 and 6. As shown in FIG. 5, the fixing plate 36 is a plate member for fixing the plurality of head units Hn to the holder member 32. The fixing plate 36 includes a plurality of opening portions 361 for exposing the nozzles Nz of the plurality of head units Hn.

The reinforcing plate 37 is disposed between the holder member 32 and the fixing plate 36 and is fixed to the fixing plate 36 by an adhesive. The reinforcing plate 37 includes a plurality of opening portions 371 in which the plurality of head units Hn are disposed.

The wiring substrate 381 is a mounting component for electrically coupling the liquid ejecting head 30 to the control circuit 21 shown in FIG. 4. The wiring substrate 381 is disposed on the laminate 333. The wiring member 382 is installed on the wiring substrate 381. The wiring member 382 is a member for electrically coupling the liquid ejecting head 30 and the control circuit 21. The wiring member 382 is, for example, a connector. The wiring member 382 may be, for example, a signal cable such as a flexible flat cable (FFC). In addition, the wiring substrate 381 and the wiring member 382 may be integrated.

The circuit boards 383u and 383v are disposed to sandwich the laminate 333. Each of the circuit boards 383u and 383v is electrically coupled to the wiring substrate 381. The flexible substrate 51 mounted on each of the head units H1 and H3 is electrically coupled to the circuit board 383u via a relay substrate (not shown). The flexible substrate 51 mounted on each of the head units H2 and H4 is electrically coupled to the circuit board 383v via a relay substrate (not shown).

### 1-6. Head Unit Hn

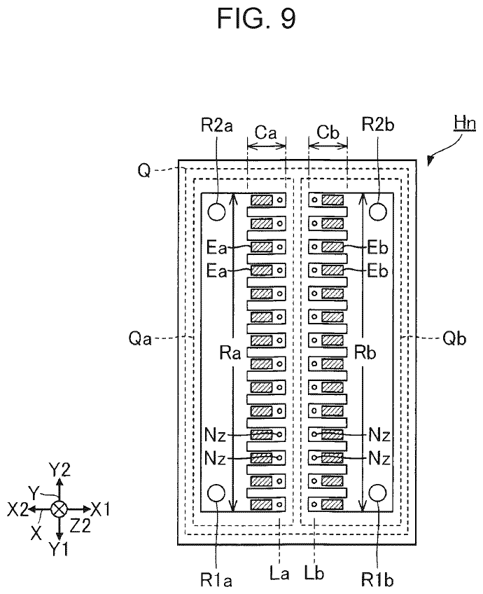

FIG. 8 is a cross-sectional view of the head unit Hn taken along the X-axis direction through the wiring hole 323. The view shown in FIG. 8 is a view of a cross-section of the head unit Hn taken along the X-axis direction through the wiring hole 323 as viewed in the Y2 direction. FIG. 9 is a plan view schematically showing the inside of the head unit Hn. The view shown in FIG. 9 is a plan view of the inside of the head unit Hn as viewed in the Z2 direction. In each of FIGS. 8 and 9, a portion of the head unit Hn shown in FIG. 6 in the vicinity of the fixing plate 36 is shown.

As shown in FIG. 8, the head unit Hn includes a nozzle plate 40, a communication plate 42, a pressure chamber substrate 43, a diaphragm 44, a plurality of drive elements E, a protection portion 46, a compliance substrate 45, and the case 335 mentioned above.

Each of the nozzle plate 40, the communication plate 42, the pressure chamber substrate 43, and the diaphragm 44 is an elongated plate-shaped member along the Y-axis. The pressure chamber substrate 43 and the case 335 are disposed in the Z1 direction with respect to the communication plate 42. On the other hand, the nozzle plate 40 and the compliance substrate 45 are disposed in the Z2 direction with respect to the communication plate 42. In addition, the members provided in the head unit Hn are joined to each other by an adhesive. Although not shown in FIG. 8, the layer formed by the adhesive joining the members provided in the head unit Hn to each other is also included in the bonding portion GL. The bonding portion GL liquid-tightly couples two members.

As shown in FIG. 9, the plurality of nozzles Nz are classified into a first nozzle row La and a second nozzle row Lb. Each of the first nozzle row La and the second nozzle row Lb is a group of a plurality of nozzles Nz arranged linearly along the Y-axis. The first nozzle row La and the second nozzle row Lb are spaced apart from each other and are arranged in the X-axis direction. Here, the liquid ejecting portion Q includes a first liquid ejecting portion Qa including a plurality of nozzles Nz belonging to the first nozzle row La, and a second liquid ejecting portion Qb including a plurality of nozzles Nz belonging to the second nozzle row Lb. The first liquid ejecting portion Qa ejects the first ink supplied from the sub tank 13a, from each nozzle Nz of the first nozzle row La. The second liquid ejecting portion Qb ejects the second ink supplied from the sub tank 13b, from each nozzle Nz of the second nozzle row Lb.

In the following description, a subscript “a” is added to reference numerals of elements related to the first nozzle row La, and a subscript “b” is added to reference numerals of elements related to the second nozzle row Lb. Additionally, elements related to the first liquid ejecting portion Qa and elements related to the second liquid ejecting portion Qb are disposed in a substantially plane-symmetrical structure. Accordingly, in the following description, elements corresponding to the first liquid ejecting portion Qa will be mainly described, and descriptions of elements corresponding to the second liquid ejecting portion Qb will be omitted as appropriate.

As shown in FIG. 8, the communication plate 42 is provided with the first communication flow path R3a and the second communication flow path R4a. Each of the first communication flow path R3a and the second communication flow path R4a is provided for each nozzle Nz. The nozzle Nz communicates with the pressure chamber Ca, which will be described below, through the first communication flow path R3a. The nozzle Nz communicates with the first liquid storage chamber Ra, which will be described below, through the second communication flow path R4a. Additionally, the compliance substrate 45 constitutes a part of a wall surface of the first liquid storage chamber Ra. The compliance substrate 45 includes, for example, a resin film 45a having flexibility and a metal plate 45b such as stainless steel.

The pressure chamber substrate 43 is provided with a plurality of pressure chambers Ca. The pressure chamber Ca is a space that communicates with the nozzle Nz via the first communication flow path R3a. The diaphragm 44 that is elastically deformable is disposed above the pressure chamber Ca. A part or all of the diaphragm 44 may be a separate member from the pressure chamber substrate 43 or may be integrated. In addition, a drive element Ea is formed for each pressure chamber Ca on a surface of the diaphragm 44 on a side opposite to the pressure chamber Ca. A plurality of drive elements Ea are disposed in one-to-one correspondence with the plurality of nozzles Nz. The drive element Ea generates energy for ejecting ink. Specifically, the drive element Ea ejects ink from the nozzle Nz by the application of the drive signal. For example, the drive element Ea is a piezoelectric element that changes the volume of the pressure chamber Ca.

The protection portion 46 is disposed above the diaphragm 44. In addition, the flexible substrate 51 is joined to a surface of the diaphragm 44. A plurality of wirings for electrically coupling the control circuit 21 and the head unit Hn are formed at the flexible substrate 51. Further, a drive circuit 50 that drives the drive element E is mounted on the flexible substrate 51. The drive circuit 50 selects whether or not to supply various signals, such as a drive signal for driving each drive element Ea, to each drive element Ea based on signals output from the control circuit 21.

The case 335 includes the first liquid storage chamber Ra for storing ink. Additionally, the case 335 includes a part of the in-head supply flow paths R1a and R1b and the in-head discharge flow paths R2a and R2b mentioned above. As shown in FIG. 8, each of the in-head supply flow path R1a and the in-head discharge flow path R2a is coupled to the first liquid storage chamber Ra. Further, as shown in FIG. 8, the case 335 includes a substrate hole 411 through which the flexible substrate 51 is inserted.

### 1-7. Shape of In-Structure Flow Path Sn

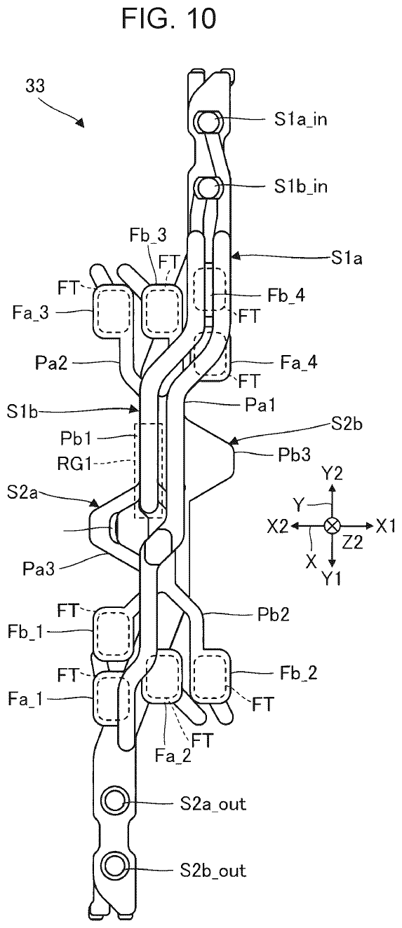

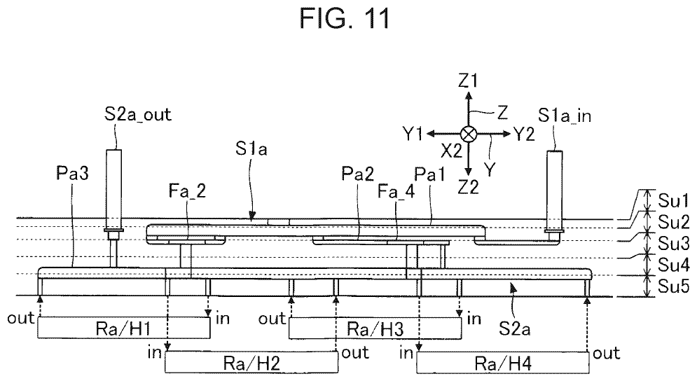

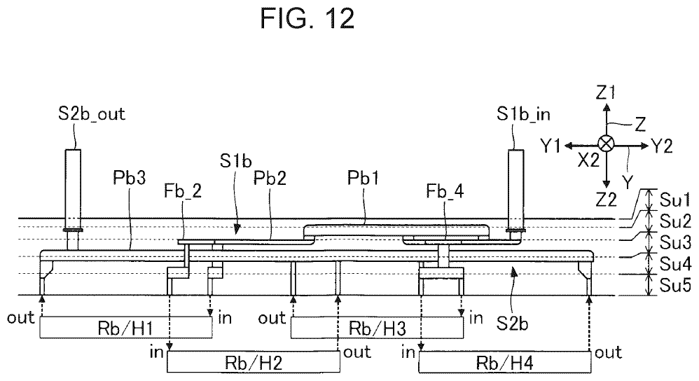

FIG. 10 is a plan view exemplifying the in-structure flow path Sn. FIG. 11 is a side view of the in-structure supply flow path S1a and the in-structure discharge flow path S2a of the in-structure flow path Sn, through which the first ink flows. FIG. 12 is a side view of the in-structure supply flow path S1b and the in-structure discharge flow path S2b of the in-structure flow path Sn, through which the second ink flows. In FIGS. 11 and 12, the first liquid storage chamber Ra of each head unit Hn is indicated by reference numeral “Ra/Hn”, and the second liquid storage chamber Rb of each head unit Hn is indicated by reference numeral “Rb/Hn”. The configuration of the in-structure flow path Sn is not limited to the following configuration.

As exemplified in FIGS. 10, 11, and 12, the flow path structure 33 is provided with the in-structure supply flow paths S1a and S1b and the in-structure discharge flow paths S2a and S2b. The in-structure supply flow path S1a is a flow path from the supply port S1a_in to the in-head supply flow path R1a of each head unit Hn, and the in-structure discharge flow path S2a is a flow path from the in-head discharge flow path R2a of each head unit Hn to the discharge port S2a_out. The in-structure supply flow path S1b is a flow path from the supply port S1b_in to the in-head supply flow path R1b of each head unit Hn, and the in-structure discharge flow path S2b is a flow path from the in-head discharge flow path R2b of each head unit Hn to the discharge port S2b_out.

As exemplified in FIGS. 10 and 11, the in-structure supply flow path S1a is a flow path including a supply portion Pa1, a coupling portion Pa2, and four filter chambers Fa_1 to Fa_4. As exemplified in FIG. 11, the supply portion Pa1 is formed between the flow path plates Su1 and Su2. The supply portion Pa1 has a shape extending along the Y-axis. An end portion of the supply portion Pa1 in the Y2 direction communicates with the supply port S1a_in.

The in-structure supply flow path S1b is a flow path including a supply portion Pb1, a coupling portion Pb2, and four filter chambers Fb_1 to Fb_4. The supply portion Pb1 is formed between the flow path plates Su1 and Su2. The supply portion Pb1 has a shape extending along the Y-axis. An end portion of the supply portion Pb1 in the Y2 direction communicates with the supply port S1b_in.

The coupling portion Pa2 and the four filter chambers Fa_1 to Fa_4 are formed between the flow path plates Su2 and Su3. The coupling portion Pa2 communicates with the supply portion Pa1 via a through-hole formed in the flow path plate Su2. The coupling portion Pa2 extends in the Y2 direction from the coupling position to the supply portion Pa1 and branches into two systems to communicate with the filter chambers Fa_1 and Fa_3.

The filter chamber Fa_2 communicates with the supply portion Pa1 via a through-hole formed in the flow path plate Su2. The filter chamber Fa_4 communicates with the supply portion Pa1 via a through-hole formed in the flow path plate Su2. Each of the filter chambers Fa_1 to Fa_4 communicates with the in-head supply flow path R1a of each head unit Hn via a through-hole penetrating through the flow path plates Su3 to Su5.

As exemplified in FIGS. 10 and 12, the in-structure supply flow path S1b is a flow path including a supply portion Pb1, a coupling portion Pb2, and four filter chambers Fb_1 to Fb_4. The supply portion Pb1 is formed between the flow path plates Su1 and Su2. The supply portion Pb1 has a shape extending along the Y-axis. The supply port S1b_in communicates with an end of the supply portion Pb1 in the Y2 direction. Here, the supply portions Pa1 and Pb1 are provided in parallel between the flow path plates Su1 and Su2.

The coupling portion Pb2 and the four filter chambers Fb_1 to Fb_4 are formed between the flow path plates Su2 and Su3. The coupling portion Pb2 communicates with the supply portion Pb1 via a through-hole formed in the flow path plate Su2. The coupling portion Pb2 extends in the Y1 direction from the coupling position to the supply portion Pb1 and branches into two systems to communicate with the filter chambers Fb_2 and Fb_4. Here, the coupling portion Pb2 extends in a direction opposite to the coupling portion Pa2 from the coupling position to the supply portion Pb1.

The filter chamber Fb_1 communicates with the supply portion Pb1 via a through-hole formed in the flow path plate Su2. The filter chamber Fb_3 communicates with the supply portion Pb1 via a through-hole formed in the flow path plate Su2. Each of the filter chambers Fb_1 to Fb_4 communicates with the in-head supply flow path R1b of each head unit Hn via a through-hole penetrating through the flow path plates Su3 to Su5.

As exemplified in FIGS. 10 and 11, the in-structure discharge flow path S2a is a flow path including a discharge portion Pa3. The discharge portion Pa3 is formed between the flow path plates Su4 and Su5. The discharge portion Pa3 has a shape that extends along the Y-axis over a wider range than the supply portion Pa1. A vicinity of an end portion of the discharge portion Pa3 in the Y1 direction communicates with the discharge port S2a_out. The in-head discharge flow path R2a of each head unit Hn communicates with the discharge portion Pa3 via a through-hole penetrating through the flow path plate Su5.

As exemplified in FIGS. 10 and 12, the in-structure discharge flow path S2b is a flow path including a discharge portion Pb3. The discharge portion Pb3 is formed between the flow path plates Su3 and Su4. The discharge portion Pb3 has a shape that extends along the Y-axis over a wider range than the supply portion Pb1. A vicinity of an end portion of the discharge portion Pb3 in the Y1 direction communicates with the discharge port S2b_out. The in-head discharge flow path R2b of each head unit Hn communicates with the discharge portion Pb3 via a through-hole penetrating through the flow path plates Su4 and Su5.

### 1-8. Accommodating Space CA and Outflow Material PS

In order to detect a sign of ink leakage from the flow path of the liquid ejecting head 30 to the outside, in the first embodiment, the accommodating space CA is provided upstream of the filter chamber Fa, and the accommodating space CA is partitioned from the flow path SF by a fragile bonding portion GLW that is intentionally made more fragile than the bonding portion GL. The accommodating space CA accommodates the outflow material PS that flows out into the flow path SF when the fragile bonding portion GLW collapses and can no longer partition the flow path SF from the accommodating space CA. When the outflow material PS flows out into the flow path SF, the filter FT is clogged, and the flow path resistance of the flow path SF abruptly increases. In general, when the flow path resistance increases, a flow rate value decreases. Therefore, in the first embodiment, it is possible to detect that the fragile bonding portion GLW collapses by periodically measuring the flow rate value with the flowmeter 29 and detecting that the flow rate value is abruptly decreased, that is, that the flow path resistance is abruptly increased. In the first embodiment, the flow rate information QI indicating the flow rate value is information regarding whether or not the filter FT is clogged with the outflow material PS.

FIG. 13 is a view illustrating the accommodating space CA and the outflow material PS. In the drawings from FIG. 13 onward, in order to prevent the drawings from being complicated, the shape of the flow path structure 33, the flow path inside the flow path structure 33, the shape of the head unit Hn, and the shape of the flow path inside the head unit Hn are shown in a simplified manner as appropriate. FIG. 13 shows a cross-section of the flow path structure 33 and the head unit Hn taken along a plane parallel to the Z-axis through the in-structure supply flow path S1a. In FIG. 13, the flow path of the in-structure supply flow path S1a in the flow path structure 33 is shown, and the flow path in the head unit Hn is omitted. Although FIG. 13 shows an example in which the accommodating space CA is provided to be partitioned from the in-structure supply flow path S1a, the accommodating space CA may be provided to be partitioned from the in-structure supply flow path S1b.

As shown in FIG. 13, the accommodating space CA is disposed upstream of the filter FT. In the example of FIG. 13, the accommodating space CA is defined by the fragile bonding portion GLW closing an opening of a recessed portion RC1 provided in an upper surface SZ11 of the in-structure supply flow path S1a in the flow path plate Su1. In the first embodiment, the accommodating space CA is provided in the upper surface SZ11 of the in-structure supply flow path S1a, but may be provided in a side surface or a bottom surface of the in-structure supply flow path S1a. However, when the accommodating space CA is provided in the side surface or the bottom surface of the in-structure supply flow path S1a, the outflow material PS is less likely to flow out into the in-structure supply flow path S1a. Therefore, by providing the accommodating space CA in the upper surface SZ11, the outflow material PS can easily flow out into the in-structure supply flow path S1a as compared with an aspect in which the accommodating space CA is provided in the side surface or the bottom surface of the in-structure supply flow path S1a.

The fragile bonding portion GLW is preferably provided to be intentionally more likely to deteriorate than a bonding portion GL that is most likely to deteriorate among a plurality of bonding portions GL in the liquid ejecting head 30. The bonding portion GL that is most likely to deteriorate among the plurality of bonding portions GL in the liquid ejecting head 30 is, when conditions of ink in contact with the plurality of bonding portions GL in the liquid ejecting head 30 are the same, a bonding portion GL having the shortest distance from a portion that defines the flow path SF in the initial state of the liquid ejecting head 30 to a portion of the bonding portion GL on a side opposite to an end defining the flow path SF. Hereinafter, in the initial state of the liquid ejecting head 30, a shortest distance from a portion where the bonding portion GL or the fragile bonding portion GLW defines the flow path SF to a portion on a side opposite to the end defining the flow path SF may be referred to as an “ink penetration distance”. In the present embodiment, the description will be given on the assumption that the bonding portion GL57 is the bonding portion GL most likely to deteriorate. However, when the conditions of ink in contact with the plurality of bonding portions GL in the liquid ejecting head 30 are different from each other, the bonding portion GL most likely to deteriorate may be a bonding portion GL provided at a location where a flow rate in the flow path SF is large, or may be a bonding portion GL provided at a location where a temperature in the flow path SF is high. A location where a temperature in the flow path SF is high is a vicinity of the drive element E, and a vicinity of a heater (not shown) that is provided when ink that needs to be used in a high temperature state, such as UV ink, is employed.

In the first embodiment, the fragile bonding portion GLW is an example of a “first bonding portion”, the bonding portion GL57 is an example of a “second bonding portion”, the flow path plate Su5 is an example of a “first flow path member”, and the case 335 is an example of a “second flow path member”. The in-structure supply flow path S1a formed in the flow path plate Su5 is an example of a “first flow path”, and the in-head supply flow path R1a formed in the case 335 is an example of a “second flow path”. However, a set of the “first flow path member” and the “second flow path member” is not limited to a set of the flow path plate Su5 and the case 335, and need only be two members constituting the liquid ejecting head 30, constituting a part of the flow path SF, and bonded using some kind of adhesive. Specifically, the set of two flow path members is a set of two adjacent flow path plates Su in the flow path structure 33, and is a set of two members constituting the head unit Hn, constituting a part of the flow path SF, and bonded using some kind of adhesive. The set of two members in the head unit Hn is specifically a set of the case 335 and the communication plate 42, a set of the communication plate 42 and the pressure chamber substrate 43, a set of the communication plate 42 and the compliance substrate 45, a set of the communication plate 42 and the nozzle plate 40, and a set of the pressure chamber substrate 43 and the diaphragm 44.

An aspect in which the fragile bonding portion GLW is intentionally made more likely to deteriorate than the bonding portion GL57 has the following two aspects. In a first aspect of the fragile bonding portion GLW, an adhesive forming the fragile bonding portion GLW and an adhesive forming the bonding portion GL57 are of the same type, and an ink penetration distance LGW of the fragile bonding portion GLW is shorter than an ink penetration distance L57 of the bonding portion GL57, as shown in FIGS. 7 and 13. The ink penetration distance LGW is a length of the fragile bonding portion GLW in the direction along the Z-axis in the initial state of the liquid ejecting head 30. In other words, the ink penetration distance LGW is the shortest distance from an end surface of the fragile bonding portion GLW in the Z2 direction that defines the in-structure supply flow path S1a to an end surface of the fragile bonding portion GLW in the Z1 direction that defines the accommodating space CA. The ink penetration distance L57 is a length of the bonding portion GL57 in the direction perpendicular to the Z-axis in the initial state of the liquid ejecting head 30. In other words, as shown in FIG. 7, the ink penetration distance L57 is the shortest distance from an end surface of the bonding portion GL57 in the X1 direction that defines the in-structure supply flow path S1a to an end surface of the bonding portion GL57 on a side opposite to the end surface in the X1 direction that defines the in-structure supply flow path S1a.

In a second aspect of the fragile bonding portion GLW, a liquid resistance of the fragile bonding portion GLW is lower than a liquid resistance of the bonding portion GL57. However, it is preferable that the liquid resistance of the fragile bonding portion GLW is slightly lower than the liquid resistance of the bonding portion GL57. For example, by changing a ratio of a main agent to a curing agent of the fragile bonding portion GLW with respect to a ratio of a main agent to a curing agent of the bonding portion GL57, it is possible to create the fragile bonding portion GLW with slightly weakened liquid resistance. Alternatively, at a time point of manufacture of the liquid ejecting head 30, it is also possible to lower a final curing degree of the fragile bonding portion GLW by locally applying heat with a laser or the like to the fragile bonding portion GLW so that a curing reaction proceeds only halfway.

The outflow material PS contains powder having a size such that the powder cannot pass through the opening of the filter FT. For example, the outflow material PS is a granular material which is an aggregate of powder. This powder is, for example, a pellet formed of an adhesive containing a filler of 10 μm or greater. Alternatively, the outflow material PS may be liquid containing powder having a size such that the powder cannot pass through the opening of the filter FT. Alternatively, when a type of ink flowing through the in-structure supply flow path S1a is known at the time point of manufacture of the liquid ejecting head 30, the outflow material PS may be an aggregate of powder having a size such that the powder cannot pass through the opening of the filter FT and a substance that dissolves in the ink flowing through the in-structure supply flow path S1a. It is preferable that the opening of the filter FT is smaller than the opening of the nozzle Nz in order to prevent foreign matter from passing through the opening of the filter FT and clogging the nozzle Nz. In this case, by making the powder of the outflow material PS have a size such that the powder of the outflow material PS cannot pass through the opening of the nozzle Nz, the opening of the filter FT can be more easily occluded with the powder of the outflow material PS.

In addition, an amount of the outflow material PS need only be an amount such that the filter FT is clogged. In the present specification, the amount such that the filter FT is clogged refers to an amount by which a flow rate value measured by the flowmeter 29 is reduced to an extent where there is a significant difference, due to the outflow material PS flowing out into the in-structure supply flow path S1a.

### 1-9. Function and Operation of First Embodiment

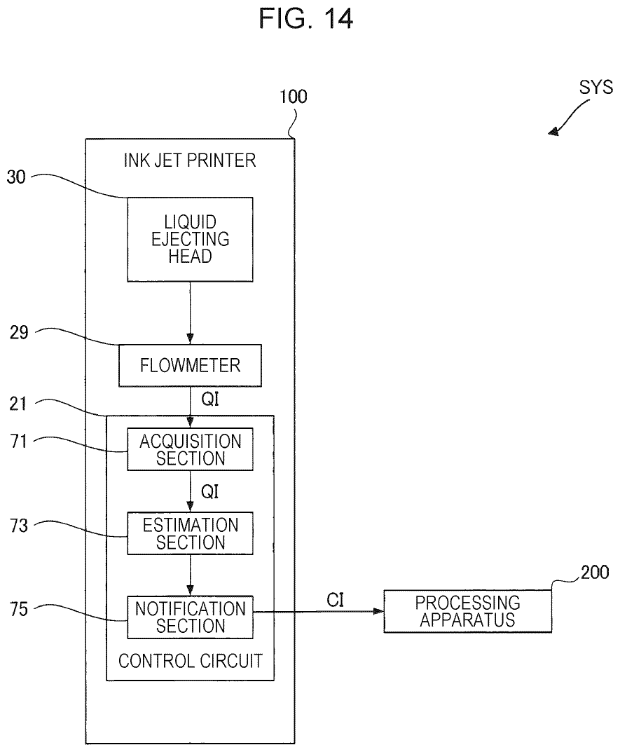

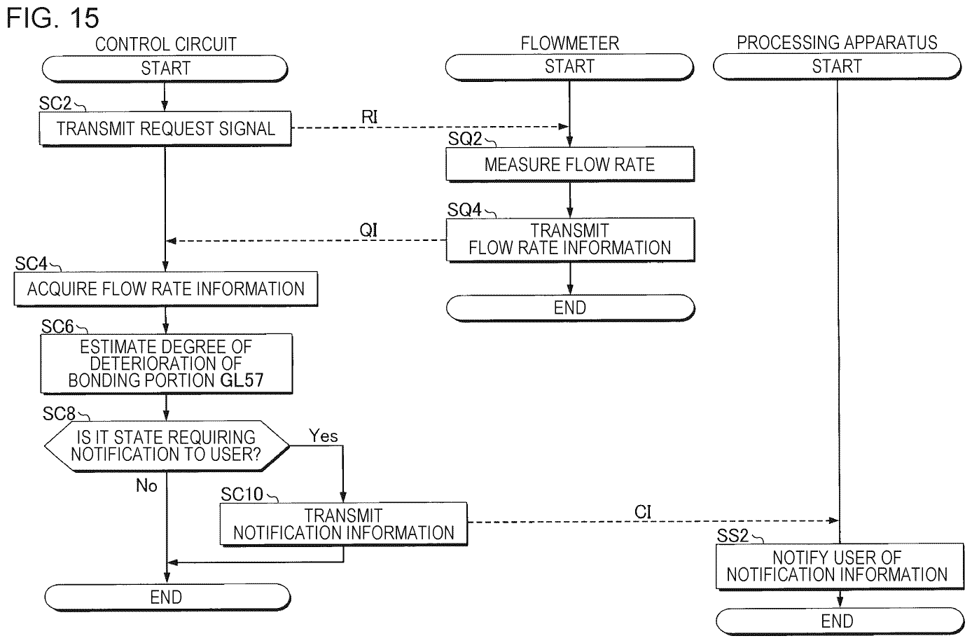

FIG. 14 is a diagram showing a function of the ink jet system SYS. FIG. 15 is a flowchart showing an operation of the ink jet system SYS. The control circuit 21 functions as an acquisition section 71, an estimation section 73, and a notification section 75 by executing the read control program PM2.

A series of processes shown in FIG. 15 are periodically executed. For example, the ink jet system SYS executes the series of processes shown in FIG. 15 every day, every week, or every month. However, the series of processes shown in FIG. 15 may be executed irregularly. For example, when the ink jet system SYS receives the image data Img from the processing apparatus 200, the ink jet system SYS may execute the series of processes shown in FIG. 15 before the printing process, or may execute the series of processes shown in FIG. 15 in response to an instruction from the user U.

In step SC2, the control circuit 21 transmits the request signal RI to the flowmeter 29. After the end of processing in step SC2, the control circuit 21 waits for a response from the flowmeter 29.

When the flowmeter 29 receives the request signal RI, the flowmeter 29 measures a flow rate of the flow path SF in step SQ2. Then, in step SQ4, the flowmeter 29 transmits the flow rate information QI indicating the measured flow rate value to the control circuit 21. After the end of processing in step SQ4, the flowmeter 29 ends the series of processes shown in FIG. 15.

The control circuit 21 functions as the acquisition section 71 to acquire the flow rate information QI from the flowmeter 29 in step SC4. Next, in step SC6, the control circuit 21 functions as the estimation section 73 to estimate the degree of deterioration of the bonding portion GL57 by determining whether or not the filter FT is clogged based on the flow rate information QI. Specifically, the estimation section 73 stores the flow rate information QI acquired by the acquisition section 71 in the storage circuit 22. For simplification of description, the flow rate value previously stored in the storage circuit 22 may be referred to as a “previous flow rate value”, and the flow rate value included in the flow rate information QI acquired by the acquisition section 71 may be referred to as a “current flow rate value”. The estimation section 73 determines whether or not the current flow rate value is less than a value obtained by subtracting a predetermined value from the previous flow rate value. When the current flow rate value is equal to or greater than the value obtained by subtracting the predetermined value from the previous flow rate value, the estimation section 73 estimates that the bonding portion GL57 is not deteriorated because the filter FT is not clogged. On the other hand, when the current flow rate value is less than the value obtained by subtracting the predetermined value from the previous flow rate value, the estimation section 73 estimates that the bonding portion GL57 is deteriorated because the filter FT is clogged. The predetermined value is a value based on a flow rate value that decreases when the outflow material PS flows out into the in-structure supply flow path S1a. The predetermined value is stored in the storage circuit 22 in advance by the head manufacturer based on experiments or experience.

After the end of processing in step SC6, in step SC8, the control circuit 21 determines whether or not it is a state requiring a notification to the user U, based on an estimation result. More specifically, when there is a liquid ejecting head 30 estimated to include the bonding portion GL57 deteriorated, the control circuit 21 determines that it is a state requiring a notification to the user U.

When a determination result in step SC8 is affirmative, in step SC10, the control circuit 21 functions as the notification section 75, generates the notification information CI based on the estimation result, and notifies the user U of the generated notification information CI. Specifically, the control circuit 21 transmits the notification information CI to the processing apparatus 200 and causes the processing apparatus 200 to notify the user U of the notification information CI. The notification information CI is information indicating that replacement of the liquid ejecting head 30 having a sign of ink leakage is prompted. For example, it is assumed that the estimation result estimates that the bonding portion GL57 is deteriorated, that is, that there is a sign of ink leakage from the liquid ejecting head 30. On this assumption, the notification information CI is a character string stating “There is a sign that the liquid ejecting head is failing. There is a sign of ink leakage from this liquid ejecting head. Please replace the liquid ejecting head”. Additionally, the notification information CI is not limited to the character string. For example, the notification information CI may be information indicating an image in which a highlighted image that highlights the liquid ejecting head 30 having a sign of ink leakage is superimposed on an image indicating the head module 3. The highlighted image is, for example, an image in which a color of the liquid ejecting head 30 having a sign of ink leakage is made different from a color of the liquid ejecting head 30 having no sign of ink leakage, or an image in which a balloon pointing to the liquid ejecting head 30 having a sign of ink leakage is provided, the balloon including a character string stating “It is recommended to replace this liquid ejecting head”.

In addition, the estimation section 73 may estimate the lifetime of the liquid ejecting head 30 based on the degree of deterioration of the bonding portion GL57 and a period from a date of start of use of the liquid ejecting head 30 to a current date. For example, the storage circuit 22 stores information indicating a date of start of use of the liquid ejecting head 30, information indicating a first period from the start of use of the liquid ejecting head 30 until ink leaks from the fragile bonding portion GLW, the information being obtained by experiments or the like conducted by the head manufacturer, and information indicating a second period from the start of use of the liquid ejecting head 30 until ink leaks from the bonding portion GL57. It is assumed that ink leakage from the fragile bonding portion GLW is detected. The estimation section 73 calculates the lifetime of the liquid ejecting head 30 by using the following Equation (1).

Lifetime of the liquid ejecting head 30=(Current date−Date of start of use of the liquid ejecting head 30)×(Second period/First period)+Current date (1)

The notification section 75 notifies the user U of lifetime information indicating the lifetime estimated by the estimation section 73, by including the lifetime information in the notification information CI. The lifetime information is, for example, a character string stating “The expected failure date of the liquid ejecting head 30 is yyyy/mm/dd”. yyyy is a four-digit numerical value. mm is an integer from 1 to 12. dd is an integer from 1 to 31. In addition, the notification section 75 may notify the user U of the notification information CI at a time point at which ink leakage from the fragile bonding portion GLW is detected, or may notify the user U of the notification information CI a predetermined number of days before a date indicated by the lifetime information.

After the end of processing in step SC10, the control circuit 21 ends the series of processes shown in FIG. 15. Additionally, when the determination result in step SC8 is negative, the control circuit 21 also ends the series of processes shown in FIG. 15.

When the processing apparatus 200 receives the notification information CI, the control circuit 210 of the processing apparatus 200 notifies the user U of the notification information CI in step SS2. Specifically, the control circuit 210 displays the character string or the image indicated by the notification information CI on the display device 270.

In FIGS. 14 and 15, the control circuit 21 functions as the estimation section 73 and the notification section 75, but the present disclosure is not limited thereto. For example, the control circuit 21 may transmit the flow rate information QI to the processing apparatus 200, and the control circuit 210 of the processing apparatus 200 may function as the estimation section 73 and the notification section 75.

### 1-10. Summary of First Embodiment

Hereinafter, a summary of the first embodiment will be described using an example in which the flow path SF corresponds to a “flow path”, the in-structure supply flow path S1a corresponds to a “first flow path”, the in-head supply flow path R1a corresponds to a “second flow path”, the flow path plate Su5 corresponds to a “first flow path member”, the case 335 corresponds to a “second flow path member”, the fragile bonding portion GLW corresponds to a “first bonding portion”, and the bonding portion GL57 corresponds to a “second bonding portion”.

The liquid ejecting head 30 includes the flow path SF that communicates with the nozzle Nz that ejects ink, the accommodating space CA, the fragile bonding portion GLW that partitions the flow path SF from the accommodating space CA, and the outflow material PS that is accommodated in the accommodating space CA and that flows out into the flow path SF when the fragile bonding portion GLW can no longer partition the flow path SF from the accommodating space CA.

According to the first embodiment, since the fragile bonding portion GLW is deteriorated upon contact with ink, and the outflow material PS flows out into the flow path SF, the user U can know that the bonding portion GL for sealing the flow path is deteriorated. The user U can know a time point at which deterioration of the bonding portion GL for sealing the flow path is detected as an appropriate timing for replacing the liquid ejecting head 30.

In addition, in the first aspect of the fragile bonding portion GLW, the liquid ejecting head 30 further includes the flow path plate Su5 that constitutes the in-structure supply flow path S1a, which is a part of the flow path SF, the case 335 that constitutes the in-head supply flow path R1a, which is a part of the flow path SF, and the bonding portion GL57 that bonds the flow path plate Su5 and the case 335 such that the in-structure supply flow path S1a and the in-head supply flow path R1a are in liquid-tight communication, and the fragile bonding portion GLW and the bonding portion GL57 are formed of the same type of adhesive.

According to the first embodiment, since the adhesive forming the fragile bonding portion GLW and the adhesive forming the bonding portion GL57 are of the same type, it is possible to make deterioration conditions of the fragile bonding portion GLW and the bonding portion GL57 the same for various inks. As a result of being able to make the deterioration conditions the same, according to the first embodiment, as compared with an aspect in which the adhesives are of different types from each other, it is possible to make degrees of progression of deterioration when the fragile bonding portion GLW and the bonding portion GL57 come into contact with ink closer, and to improve accuracy of estimating the degree of deterioration of the bonding portion GL57.

Additionally, in the first aspect of the fragile bonding portion GLW, the ink penetration distance LGW, which is the shortest distance from a portion of the fragile bonding portion GLW that defines the flow path SF to a portion of the fragile bonding portion GLW that defines the accommodating space CA, is shorter than the ink penetration distance L57, which is the shortest distance from a portion of the bonding portion GL57 that defines the flow path SF to the end portion of the bonding portion GL57 on a side opposite to the portion that defines the flow path SF.

According to the first embodiment, as compared with an aspect in which the ink penetration distance LGW is longer than the ink penetration distance L57, it is possible to detect a sign of ink leakage from the bonding portion GL57 before a time point at which ink leaks from the bonding portion GL57.

In addition, in the second aspect of the fragile bonding portion GLW, the liquid resistance of the fragile bonding portion GLW is lower than the liquid resistance of the bonding portion GL57.

According to the first embodiment, it is possible to detect a sign of ink leakage from the bonding portion GL57 before a time point at which ink leaks from the bonding portion GL57.

Additionally, the liquid ejecting head 30 includes the filter FT disposed downstream of the accommodating space CA in the flow path SF, and the outflow material PS contains powder having a size such that the powder cannot pass through the opening of the filter FT.

According to the first embodiment, it is possible to estimate the degree of deterioration of the bonding portion GL57 by using the flowmeter 29, based on the fact that the filter FT is clogged and the flow path resistance is increased.

In addition, the control circuit 21 of the ink jet printer 100 functions as the acquisition section 71 that acquires the flow rate information QI, which is information regarding whether or not the filter FT is clogged with the outflow material PS, and the estimation section 73 that estimates the degree of deterioration of the bonding portion GL57 based on the flow rate information QI acquired by the acquisition section 71.

According to the first embodiment, the degree of deterioration of the bonding portion GL57 can be estimated based on the flow rate information QI. Further, according to the present embodiment, it is possible to detect a sign of ink leakage from the liquid ejecting head 30 without destroying the liquid ejecting head 30.

Additionally, the control circuit 21 also functions as the notification section 75 that issues a notification prompting the replacement of the liquid ejecting head 30 when the estimation section 73 estimates that the bonding portion GL57 is deteriorated.

According to the first embodiment, the user U can replace the liquid ejecting head 30 before ink leaks from the liquid ejecting head 30 by replacing the liquid ejecting head 30 in response to the notification prompting the replacement of the liquid ejecting head 30.

In the first embodiment, the ink jet printer 100 includes the flowmeter 29, but may include a pressure gauge instead of the flowmeter 29. The change in flow path resistance can also be detected by the pressure gauge.

The amount of the outflow material PS may be an amount such that the filter FT can be occluded. The amount such that the filter FT can be occluded refers to an amount that is greater than an amount such that the filter FT is clogged, and that is such that, when the outflow material PS flows out into the in-structure supply flow path S1a, ejection failure occurs in a predetermined ratio or greater of the nozzles Nz among all the nozzles Nz communicating with the in-structure supply flow path S1a. The predetermined ratio is a value set by the head manufacturer based on experiments or experience.

In an aspect in which the amount of the outflow material PS is an amount such that the filter FT can be occluded, a change in flow path resistance becomes greater, and estimation of the degree of deterioration of the bonding portion GL57 by the measurement of the flow rate by the flowmeter 29 becomes easier. Since ejection failure occurs in the predetermined ratio or greater of the nozzles Nz among all the nozzles Nz communicating with the in-structure supply flow path S1a, the user U may know a sign of ink leakage from the liquid ejecting head 30 by confirming an image formed on the medium PP, even when the flowmeter 29 does not measure the flow rate of the flow path SF. That is, when the amount of the outflow material PS is an amount such that the filter FT can be occluded, the control circuit 21 of the ink jet printer 100 need not function as the acquisition section 71, the estimation section 73, and the notification section 75. For example, when the quality of the image formed on the medium PP is not acceptable to the user U, the user U replaces the liquid ejecting head 30. Additionally, since the user U can restrict use of the liquid ejecting head 30 until the liquid ejecting head 30 having a sign of ink leakage is replaced, it is possible to prevent the inside of the liquid ejecting head 30 from being contaminated or electronic components from failing when the liquid ejecting head 30 continues to be used. As a result, the head manufacturer can manufacture a regenerated liquid ejecting head 30 by collecting the liquid ejecting head 30 before electrical components of the liquid ejecting head 30 fail, and using the collected liquid ejecting head 30. Since the head manufacturer can manufacture the liquid ejecting head 30 regenerated by using the collected liquid ejecting head 30 at a lower cost than a new liquid ejecting head 30, the regenerated liquid ejecting head 30 can be provided at a low cost to a printer manufacturer or the user U.

### 2. Second Embodiment

In the first embodiment, the degree of deterioration of the bonding portion GL57 is estimated by detecting that the flow path resistance of the flow path SF abruptly increases when the outflow material PS flows out into the flow path SF, but the present disclosure is not limited thereto. In a second embodiment, the degree of deterioration of the bonding portion GL57 is estimated by detecting that a color of the image formed on the medium PP is abnormal when the outflow material PS flows out into the flow path SF. The second embodiment will be described below.

### 2-1. Overview of Second Embodiment

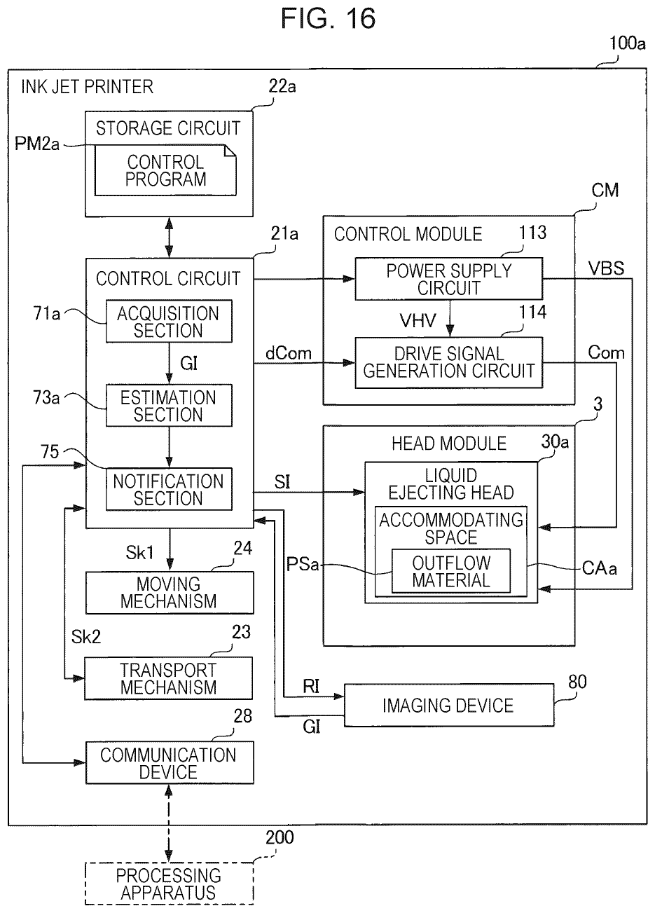

FIG. 16 is a block diagram showing a configuration example of an ink jet printer 100a in the second embodiment. The ink jet printer 100a includes a liquid ejecting head 30a instead of the liquid ejecting head 30, includes a control circuit 21a instead of the control circuit 21, includes a storage circuit 22a instead of the storage circuit 22, and includes an imaging device 80 instead of the flowmeter 29. The liquid ejecting head 30a is provided with an accommodating space CAa instead of the accommodating space CA, and an outflow material PSa is accommodated in the accommodating space CAa instead of the outflow material PS.

The outflow material PSa has the following two aspects. In a first aspect of the outflow material PSa, the outflow material PSa contains a color material containing at least one of a dye and a pigment. For example, the outflow material PSa may be ink containing at least one of a dye and a pigment, or may be a granular material that is an aggregate of powder containing at least one of a dye and a pigment. The color of the color material contained in the outflow material PSa is preferably different from a color of ink flowing through the flow path SF, from the viewpoint that the color of the image formed on the medium PP is abnormal when the outflow material PS flows out into the flow path SF. However, since the color of ink flowing through the flow path SF is decided on by the user U, the color of ink flowing through the flow path SF may be unknown at the time point of manufacture of the liquid ejecting head 30a. Accordingly, for example, the color of the color material contained in the outflow material PSa is preferably a color that is less frequently employed generally as an ink color. The color of ink that is less frequently employed generally as an ink color is, for example, a color other than cyan, magenta, yellow, and black.

In addition, in the first aspect of the outflow material PSa, the outflow material PSa may contain two or more color materials containing at least one of a dye and a pigment and having different colors. In the present specification, having different colors means that, when any two color materials among two or more color materials are chromatic colors, one or more of hue, saturation, and brightness are different, and that a color difference ΔE is equal to or greater than 13. Further, when the colors of any two color materials are achromatic colors, it means that the brightness is different and the color difference ΔE is equal to or greater than 13. Furthermore, the phrase “the outflow material PSa contains two or more color materials” means that one outflow material PSa may contain two or more color materials, or that the accommodating space CAa may include an outflow material PSa containing a color material of a certain color and an outflow material PSa containing a color material of a color different from the certain color. Alternatively, the liquid ejecting head 30a may be provided with two or more accommodating spaces CAa, and the outflow materials PSa containing color materials of different colors may be accommodated in the two or more accommodating spaces CAa, respectively.

In a second aspect of the outflow material PSa, the outflow material PSa contains a phosphor that reacts with ultraviolet light to emit light when irradiated with the ultraviolet light. For example, the phosphor is a fluorescent pigment such as strontium sulfide or strontium aluminate. The phosphor reacts with ultraviolet light to emit light such as blue, yellow, or red. It is preferable that the phosphor is colorless and transparent or white, because it is preferable that the phosphor is not visually recognized by the user U under visible light.

The accommodating space CAa may be disposed at any portion of the flow path SF. Specifically, the accommodating space CAa may be disposed either upstream or downstream of the filter FT. Additionally, the accommodating space CAa may be disposed in the in-head supply flow path R1a.

The imaging device 80 captures the image formed on the medium PP. The imaging device 80 includes an imaging optical system and an imaging element. The imaging optical system is an optical system including at least one imaging lens, and may include various optical elements such as a prism, or may include a zoom lens, a focus lens, or the like. From the viewpoint that it is easy to image a detection surface with the imaging element, it is preferable that the imaging optical system includes a wide-angle lens or a fisheye lens. The imaging element includes, for example, a charge coupled device (CCD) image sensor, a complementary MOS (CMOS) image sensor, or the like. When the imaging element receives the request signal RI from the control circuit 21a, the imaging element captures an image via the imaging optical system and transmits image information GI indicating the captured image to the control circuit 21a.

In addition, in the second aspect of the outflow material PSa, the imaging device 80 includes a light source capable of emitting ultraviolet light.

The storage circuit 22a differs from the storage circuit 22 in that a control program PM2a is stored instead of the control program PM2. As shown in FIG. 16, the control circuit 21a functions as an acquisition section 71a, an estimation section 73a, and the notification section 75 by executing the read control program PM2a.

### 2-2. Operation of Second Embodiment

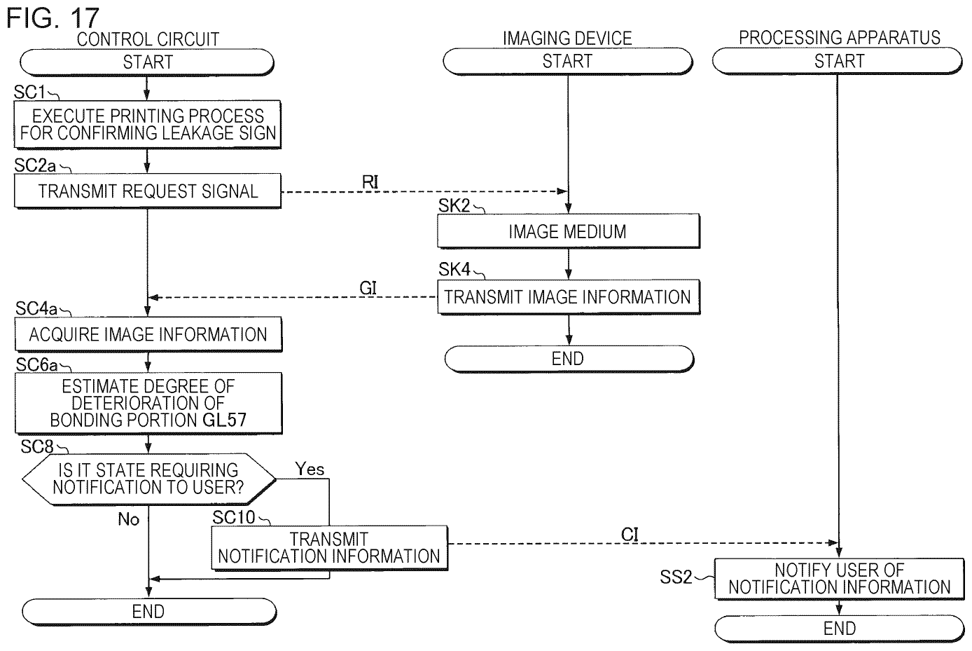

FIG. 17 is a flowchart showing an operation of the ink jet system SYS in the second embodiment. Hereinafter, only differences from FIG. 15 will be described.

In step SC1, the control circuit 21a executes the printing process for confirming a leakage sign. The printing process for confirming the leakage sign is a process of forming a pattern image indicating a predetermined test pattern on the medium PP. Information indicating the pattern image is stored in advance in the storage circuit 22a. The pattern image includes dots formed by ejecting ink from the liquid ejecting head 30a.

After the end of processing in step SC1, in step SC2a, the control circuit 21a transmits the request signal RI to the imaging device 80. After the end of processing in step SC2a, the control circuit 21a waits for a response from the imaging device 80.

When the imaging device 80 receives the request signal RI, the imaging device 80 captures the pattern image formed on the medium PP by ink ejected from the liquid ejecting head 30a in step SK2. In the second aspect of the outflow material PSa, the imaging device 80 captures the pattern image formed on the medium PP in a state in which the medium PP is irradiated with ultraviolet rays by the light source. Hereinafter, the pattern image in step SK2 may be referred to as a “comparison image”. Then, in step SK4, the imaging device 80 transmits the image information GI indicating the comparison image formed on the medium PP to the control circuit 21a. After the end of processing in step SK4, the imaging device 80 ends the series of processes shown in FIG. 17. The image information GI is information regarding whether or not the color of liquid flowing in the flow path SF is abnormal.

The control circuit 21a functions as the acquisition section 71a to acquire the image information GI from the imaging device 80 in step SC4a. Next, in step SC6a, the control circuit 21a functions as the estimation section 73a to estimate the degree of deterioration of the bonding portion GL57 based on the image information GI, depending on whether or not the color of liquid flowing in the flow path SF is abnormal. Specifically, at a time point of the start of use of the liquid ejecting head 30a, the printing process for confirming a leakage sign is executed, and the image information indicating the image formed on the medium PP is stored in the storage circuit 22a. Hereinafter, the image indicated by the image information stored in the storage circuit 22a at a time point of the start of use of the liquid ejecting head 30a may be referred to as an “initial image”. The estimation section 73a compares a color of a dot formed by ink ejected from the liquid ejecting head 30a in the initial image with a color of a dot formed by ink ejected from the liquid ejecting head 30a in the comparison image. When the estimation section 73a determines that the two colors are the same, the estimation section 73a estimates that the color of liquid flowing in the flow path SF is normal and the bonding portion GL57 is not deteriorated. On the other hand, when the estimation section 73a determines that the two colors are different from each other, the estimation section 73a estimates that the color of liquid flowing in the flow path SF is abnormal and the bonding portion GL57 is deteriorated.

### 2-3. Summary of Second Embodiment

As described above, in the first aspect of the outflow material PSa, the outflow material PSa in the second embodiment contains the color material containing at least one of a dye and a pigment.

According to the second embodiment, it is possible to detect whether or not the bonding portion GL57 is deteriorated based on the abnormality of the color of the image formed on the medium PP.

In addition, in the first aspect of the outflow material PSa, the outflow material PSa may contain two or more color materials having different colors.

As mentioned above, at the time point of manufacture of the liquid ejecting head 30a, the color of ink flowing through the flow path SF may be unknown. Therefore, in the aspect in which the outflow material PSa is one color material, the color of the color material contained in the outflow material PSa may be the same as the color of ink flowing through the flow path SF. In a case where the color of the color material contained in the outflow material PSa is the same as the color of ink flowing through the flow path SF, the color of the image formed on the medium PP does not change when the outflow material PSa flows out into the flow path SF, and collapse of the fragile bonding portion GLW may not be detected. Accordingly, since the outflow material PSa contains two or more color materials having different colors, the outflow material PSa contains a color material different from the color of ink in the flow path SF, so that regardless of what color the ink in the flow path SF is, when the outflow material PSa flows out into the flow path SF, the color of the image formed on the medium PP can be changed. Therefore, according to the second aspect of the outflow material PSa, the user U can use the same type of liquid ejecting head 30a for various inks.

Additionally, in the second aspect of the outflow material PSa, the outflow material PSa contains a phosphor that reacts with ultraviolet light to emit light when irradiated with the ultraviolet light.

In either the first aspect of the outflow material PSa or the second aspect of the outflow material PSa, when the outflow material PSa flows out into the flow path SF, a part of ink ejected from the nozzle Nz is replaced with the color material or the phosphor of the outflow material PSa, so that as compared with a state in which the outflow material PSa does not flow out into the flow path SF, the quality of the image formed on the medium PP deteriorates. However, in the first aspect of the outflow material PSa, the color material of the outflow material PSa contained in the image formed on the medium PP is easily noticed by the user U, whereas in the second aspect of the outflow material PSa, since the phosphor is not conspicuous under visible light, the phosphor contained in the image formed on the medium PP is less likely to be noticed by the user U. Accordingly, according to the second aspect of the outflow material PSa, as compared with the first aspect of the outflow material PSa, even when the outflow material PSa flows out into the flow path SF, the user U can be less likely to notice deterioration in the quality of the image formed on the medium PP.

In addition, the control circuit 21a of the ink jet printer 100a functions as the acquisition section 71a that acquires the image information GI, which is information regarding whether or not the color of the liquid flowing in the flow path SF is abnormal, and the estimation section 73a that estimates the degree of deterioration of the bonding portion GL57 based on the image information GI acquired by the acquisition section 71a.

According to the second embodiment, by acquiring the image information GI, the degree of deterioration of the bonding portion GL57 can be estimated.

Additionally, the control circuit 21a also functions as the notification section 75 that issues a notification prompting the replacement of the liquid ejecting head 30a when the estimation section 73a estimates that the bonding portion GL57 is deteriorated.

The user U can replace the liquid ejecting head 30a before ink leaks from the liquid ejecting head 30a by replacing the liquid ejecting head 30a in response to the notification prompting the replacement of the liquid ejecting head 30a.

In the second embodiment, the imaging device 80 captures the image formed on the medium PP, but the present disclosure is not limited thereto. For example, the imaging device 80 may capture an image of waste liquid in a waste liquid tank (not shown). The waste liquid tank is used for a cleaning process for recovering from an ejection abnormality of the liquid ejecting head 30a. The fragile bonding portion GLW may collapse while the cleaning process is being executed, and the color material contained in the outflow material PSa may be discharged to the waste liquid tank. Therefore, the imaging device 80 captures the image of the waste liquid in the waste liquid tank and transmits image information indicating the captured image to the control circuit 21a. The control circuit 21a may estimate the degree of deterioration of the bonding portion GL57 by using image information indicating the image obtained by capturing the inside of the waste liquid tank. In order to improve the estimation accuracy of the degree of deterioration of the bonding portion GL57, it is preferable that the imaging device 80 captures both the image formed on the medium PP and the image of the waste liquid in the waste liquid tank. For example, the ink jet printer 100a may include the imaging device 80 for capturing the image formed on the medium PP and the imaging device 80 for capturing the image of the waste liquid in the waste liquid tank, or the imaging device 80 may be movably installed to capture the image formed on the medium PP and the image of the waste liquid in the waste liquid tank.

In the second embodiment, the user U may determine whether or not there is a sign of ink leakage from the liquid ejecting head 30a by observing at least one of the image formed on the medium PP and the waste liquid in the waste liquid tank. In the second aspect of the outflow material PSa, the user U can determine whether or not there is a sign of ink leakage from the liquid ejecting head 30a by irradiating the image formed on the medium with ultraviolet rays using an ultraviolet irradiation device. In an aspect in which the user U determines whether or not there is a sign of ink leakage from the liquid ejecting head 30a by observing at least one of the image formed on the medium PP and the waste liquid in the waste liquid tank, the ink jet printer 100a need not include the imaging device 80, and the control circuit 21a need not function as the acquisition section 71a, the estimation section 73a, and the notification section 75.

### 3. Third Embodiment

In the first embodiment, the outflow material PS is accommodated in the accommodating space CA, but the outflow material PS may be contained in the fragile bonding portion GLW disposed in the flow path SF. In order to facilitate understanding, the fragile bonding portion GLW containing the outflow material PS may be referred to as an outflow material-containing bonding portion GLP. A third embodiment will be described below.

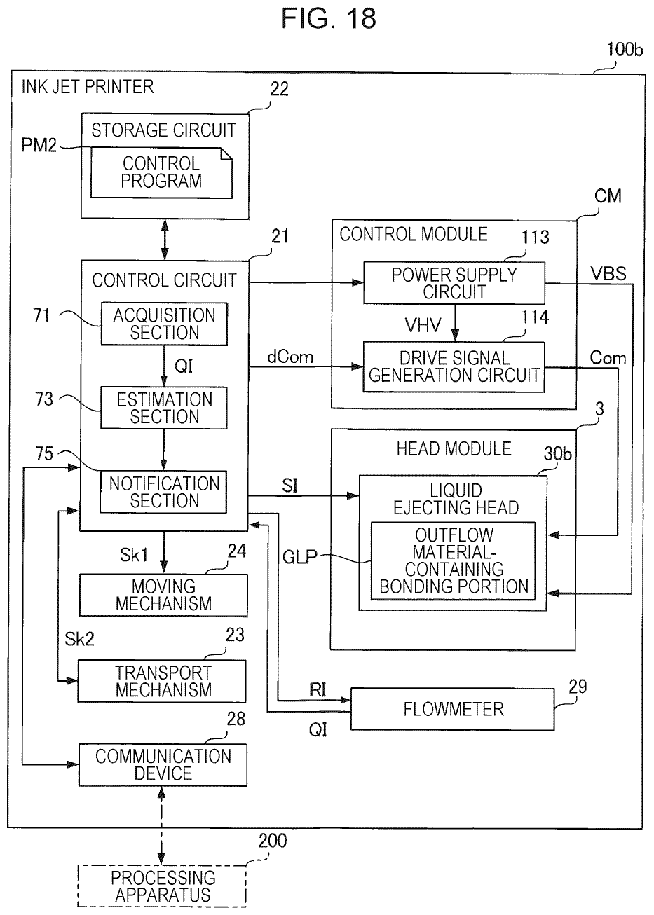

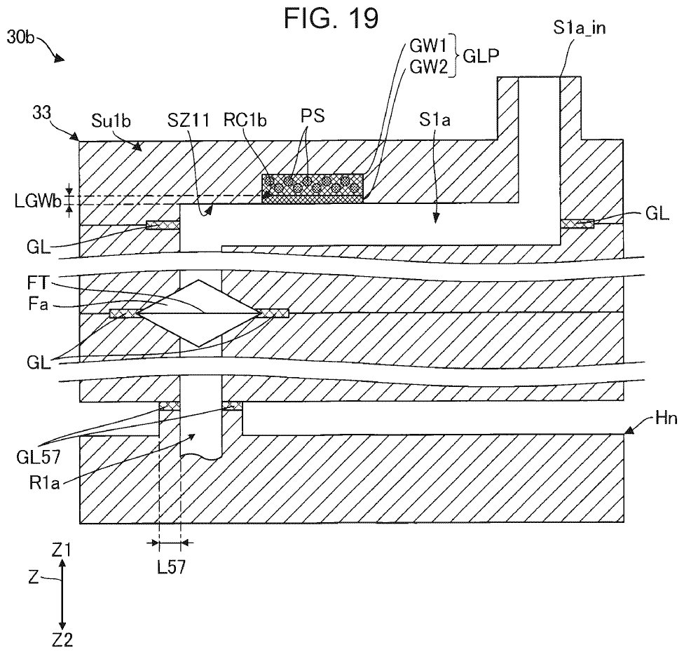

FIG. 18 is a block diagram showing a configuration example of an ink jet printer 100b in the third embodiment. The ink jet printer 100b includes a liquid ejecting head 30b instead of the liquid ejecting head 30. The liquid ejecting head 30b includes the outflow material-containing bonding portion GLP containing the outflow material PS in the first embodiment, instead of the accommodating space CA. The liquid ejecting head 30b will be described with reference to FIG. 19.

FIG. 19 is a view illustrating the outflow material-containing bonding portion GLP. The liquid ejecting head 30b includes a flow path plate Su1b instead of the flow path plate Su1. A recessed portion RC1b provided in the upper surface SZ11 of the in-structure supply flow path S1a in the flow path plate Su1b is filled with the outflow material-containing bonding portion GLP. The outflow material-containing bonding portion GLP is disposed at a position where flow paths of two laminated flow path members are not liquid-tightly coupled to each other, and in other words, the outflow material-containing bonding portion GLP does not have a function of sealing the flow path. That is, the outflow material-containing bonding portion GLP need not be bonded to the plurality of flow path members and may be bonded only to the flow path plate Su1b, which is one flow path member. The outflow material-containing bonding portion GLP is intentionally made more fragile than the bonding portion GL. The outflow material-containing bonding portion GLP includes a first layer GW1 containing the outflow material PS and a second layer GW2 not containing the outflow material PS. For example, the head manufacturer forms the first layer GW1 by filling the recessed portion RC1b with an adhesive containing the outflow material PS, and after the first layer GW1 is cured, forms the second layer GW2 by filling the recessed portion RC1b with an adhesive not containing the outflow material PS. In the initial state of the liquid ejecting head 30b, the surface of the second layer GW2 in the Z2 direction is in contact with the ink. The outflow material-containing bonding portion GLP is an example of a “third bonding portion”.

In the third embodiment as well, similarly to the first and second embodiments, the outflow material PS mixed into the outflow material-containing bonding portion GLP needs to flow out into the flow path SF before ink leaks from the bonding portion GL57. An aspect in which the outflow material-containing bonding portion GLP that causes the outflow material PS mixed into the outflow material-containing bonding portion GLP to flow out into the flow path SF before ink leaks from the bonding portion GL57 has the following two aspects. In a first aspect of the outflow material-containing bonding portion GLP, the adhesive forming the outflow material-containing bonding portion GLP and the adhesive forming the bonding portion GL57 are of the same type, and a thickness LGWb of the second layer GW2 is shorter than the ink penetration distance L57 of the bonding portion GL57. The thickness LGWb is the shortest distance from an end surface of the outflow material-containing bonding portion GLP in the Z2 direction that defines the in-structure supply flow path S1a to an end surface of the first layer GW1 in the Z2 direction.

In a second aspect of the outflow material-containing bonding portion GLP, the liquid resistance of the outflow material-containing bonding portion GLP is lower than the liquid resistance of the bonding portion GL57. However, it is preferable that the liquid resistance of the outflow material-containing bonding portion GLP is slightly lower than the liquid resistance of the bonding portion GL57.

In addition, similarly to the first embodiment, the filter FT disposed downstream of the outflow material-containing bonding portion GLP in the flow path SF is provided. An amount of the outflow material PS mixed into the outflow material-containing bonding portion GLP may be an amount such that the filter FT is clogged, or may be an amount such that the filter FT can be occluded.

Additionally, the control circuit 21 of the ink jet printer 100b functions as the acquisition section 71 that acquires the flow rate information QI, which is information regarding whether or not the filter FT is clogged with the outflow material PS, and the estimation section 73 that estimates the degree of deterioration of the bonding portion GL57 based on the flow rate information QI acquired by the acquisition section 71. Further, the control circuit 21 of the ink jet printer 100b may also function as the notification section 75 that issues a notification prompting the replacement of the liquid ejecting head 30b when the estimation section 73 estimates that the bonding portion GL57 is deteriorated.

As described above, the liquid ejecting head 30b in the third embodiment includes the flow path SF that communicates with the nozzle Nz that ejects ink, and the outflow material-containing bonding portion GLP disposed in the flow path SF, and the outflow material-containing bonding portion GLP contains the outflow material PS that flows out into the flow path SF when the outflow material-containing bonding portion GLP is eluted into the ink in the flow path SF.

According to the third embodiment, since the outflow material-containing bonding portion GLP deteriorates upon contact with ink, and the outflow material PS flows out into the flow path SF, the user U can know that the bonding portion GL for sealing the flow path is deteriorated. The user U can know a time point at which deterioration of the bonding portion GL for sealing the flow path is detected as an appropriate timing for replacing the liquid ejecting head 30b.

### 4. Modification Examples

Each of the aspects exemplified above can be variously modified. Specific modification aspects that can be applied to each of the aspects mentioned above will be exemplified below. Two or more aspects optionally selected from the following examples can be combined as appropriate within a range in which the aspects are not mutually contradictory.

### 4-1. First Modification Example

In the third embodiment, the outflow material-containing bonding portion GLP is provided in the recessed portion RC1b provided in the upper surface SZ11 of the in-structure supply flow path S1a in the flow path plate Su1b, but the present disclosure is not limited thereto. For example, the outflow material-containing bonding portion GLP may be provided in the filter chamber Fa and may be placed on the filter FT.

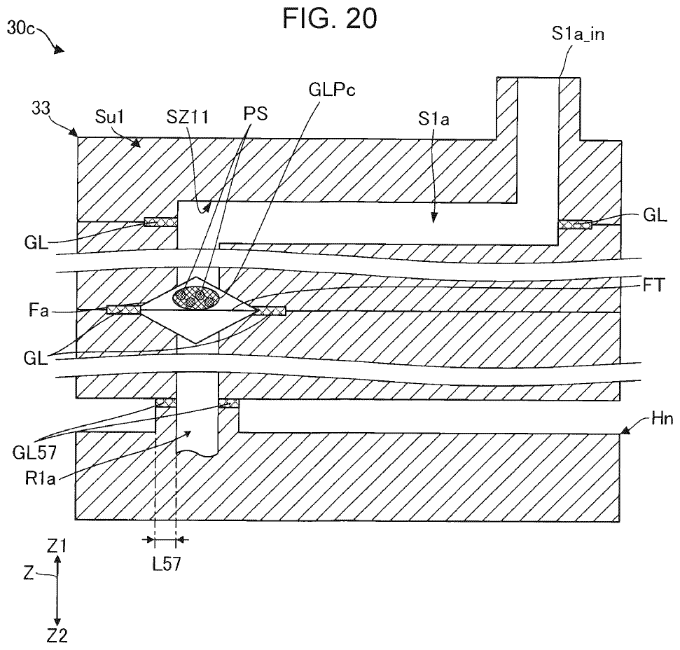

FIG. 20 is a view illustrating an outflow material-containing bonding portion GLPc in a first modification example. A liquid ejecting head 30c includes the outflow material-containing bonding portion GLPc in the filter chamber Fa.

The outflow material-containing bonding portion GLPc is provided in the filter chamber Fa and is placed on the filter FT. Additionally, the outflow material-containing bonding portion GLPc does not include a layer in which the outflow material PS is not mixed. In the first modification example, the estimation section 73 need only estimate that the bonding portion GL57 is deteriorated when the flow rate value indicated by the flow rate information QI reaches the flow rate value in a case where all of the outflow material PS contained in the outflow material-containing bonding portion GLPc flows out into the flow path SF.

### 4-2. Second Modification Example

The liquid ejecting head 30b in the third embodiment and the liquid ejecting head 30c in the first modification example include the outflow material-containing bonding portion GLP containing the outflow material PS in the first embodiment, but may include the outflow material-containing bonding portion GLP containing the outflow material PSa in the second embodiment.

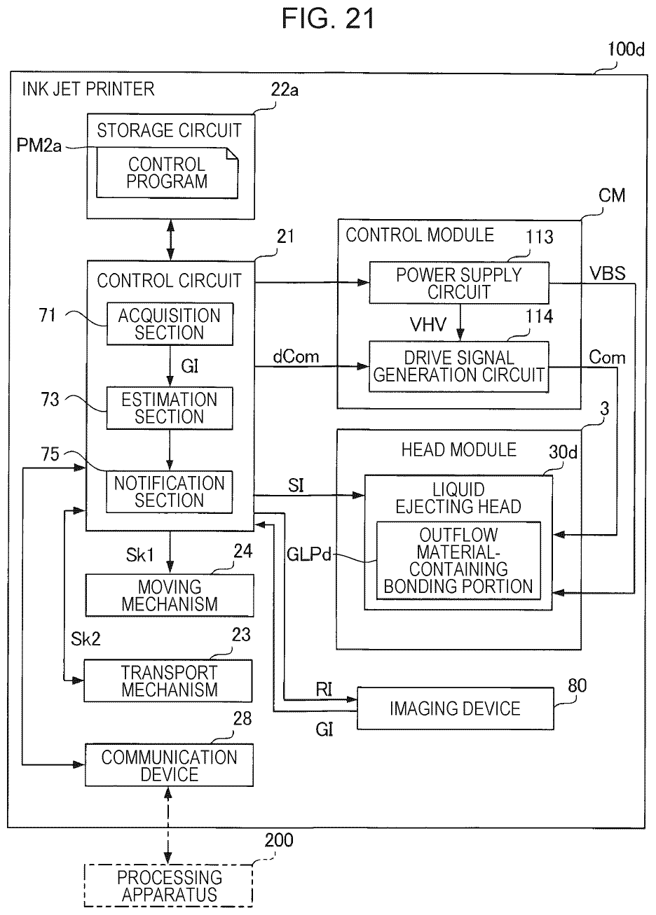

FIG. 21 is a block diagram showing a configuration example of an ink jet printer 100d in a second modification example. The ink jet printer 100d includes a liquid ejecting head 30d instead of the liquid ejecting head 30a. The liquid ejecting head 30d includes an outflow material-containing bonding portion GLPd containing the outflow material PSa instead of the outflow material PS.

The outflow material-containing bonding portion GLPd includes a first layer GW1d instead of the first layer GW1. The first layer GW1d contains the outflow material PSa instead of the outflow material PS.

In the second modification example as well, similarly to the second embodiment, both the first aspect of the outflow material PSa and the second aspect of the outflow material PSa can be employed.

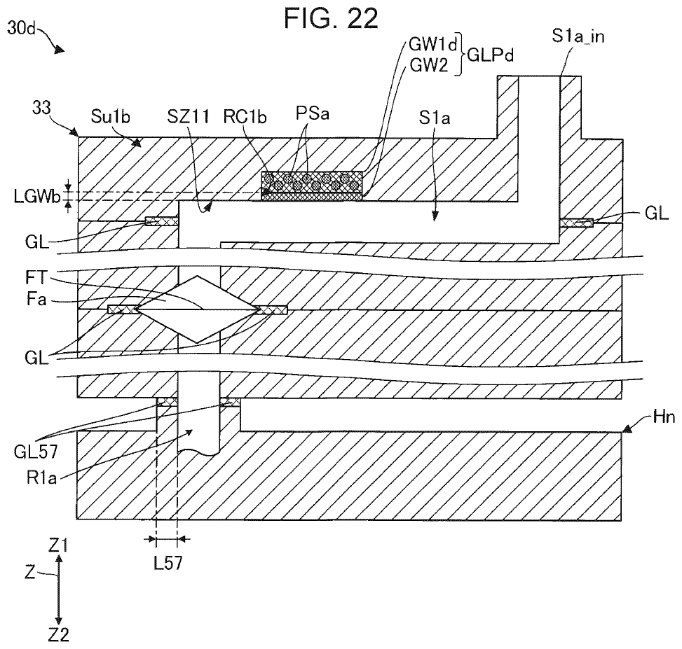

In the example of FIG. 22 illustrating the outflow material-containing bonding portion GLPd, the outflow material-containing bonding portion GLPd is disposed upstream of the filter FT, but the present disclosure is not limited thereto, and similarly to the second embodiment, the outflow material-containing bonding portion GLPd may be disposed at any portion of the flow path SF. Specifically, the outflow material-containing bonding portion GLPd may be disposed either upstream or downstream of the filter FT.

In addition, the control circuit 21 of the ink jet printer 100d functions as the acquisition section 71 that acquires the image information GI, which is information regarding whether or not the color of the liquid flowing in the flow path SF is abnormal, and the estimation section 73 that estimates the degree of deterioration of the bonding portion GL57 based on the image information GI acquired by the acquisition section 71. Further, the control circuit 21 of the ink jet printer 100d may also function as the notification section 75 that issues a notification prompting the replacement of the liquid ejecting head 30d when the estimation section 73 estimates that the bonding portion GL57 is deteriorated.

### 4-3. Third Modification Example

The accommodating space CA in the first and second embodiments is defined by the fragile bonding portion GLW closing the opening of the recessed portion RC1 provided in the upper surface SZ11, but the present disclosure is not limited thereto. For example, the accommodating space CA may be a bypass flow path that branches from the flow path SF and that merges with the flow path SF downstream of a branching point.

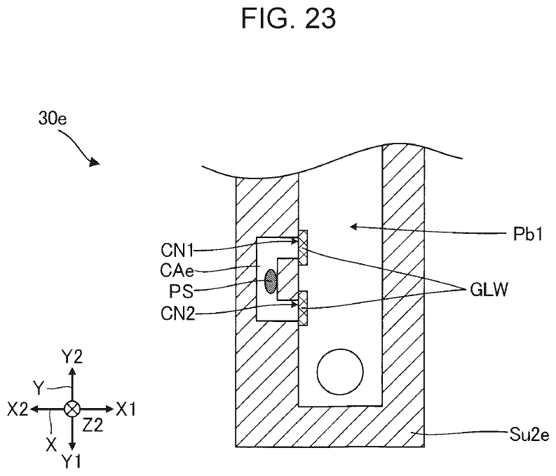

FIG. 23 is a view illustrating an accommodating space CAe in a third modification example. FIG. 23 shows a cross-section of the supply portion Pb1 in a region RG1 shown in FIG. 10 in the liquid ejecting head 30e in the third modification example, taken along a plane parallel to the XY plane.

The liquid ejecting head 30e includes a flow path plate Su2e instead of the flow path plate Su2. The accommodating space CAe is a bypass flow path that merges with the supply portion Pb1 at a second coupling portion CN2 different from a first coupling portion CN1 of the supply portion Pb1. The accommodating space CAe is defined by the fragile bonding portion GLW closing the first coupling portion CN1 and the second coupling portion CN2.

### 4-4. Fourth Modification Example

In the first embodiment, the third embodiment, the first modification example, and a fourth modification example in any one aspect of the first embodiment, the third embodiment, and the first modification example, a change in flow path resistance of the flow path SF is detected by the flowmeter 29 or the pressure gauge, but the present disclosure is not limited thereto. For example, when the drive element E is a piezoelectric element, a change in flow path resistance of the flow path SF may also be detected based on information indicating residual vibration that indicates vibration remaining in the pressure chamber C after the drive element E is driven.

### 4-5. Fifth Modification Example

In each of the aspects mentioned above, the liquid ejecting head 30 may include the outflow material PS corresponding to each of two or more bonding portions GL. For example, the liquid ejecting head 30 may include the outflow material PS for detecting a sign of ink leakage from the bonding portion GL in the head unit Hn, and the outflow material PS for detecting a sign of ink leakage from the bonding portion GL in the flow path structure 33. The estimation section 73 in a fifth modification example estimates the degree of deterioration of the bonding portion GL in the head unit Hn and the degree of deterioration of the bonding portion GL in the flow path structure 33. The notification section 75 in the fifth modification example notifies the user U of a character string indicating a position of the liquid ejecting head 30 where there is a sign of ink leakage, as the notification information CI. The character string indicating a position where there is a sign of ink leakage is, for example, when it is estimated that the bonding portion GL in the flow path structure 33 is deteriorated, the notification information CI indicating “There is a sign of ink leakage in the flow path structure”.

In addition, by providing the outflow material PS corresponding to each of two or more bonding portions GL in the liquid ejecting head 30, the head manufacturer may replace the portion where there is a sign of ink leakage. For example, the outflow material PS corresponding to each of the bonding portion GL in the flow path structure 33 in the liquid ejecting head 30 and the bonding portion GL in each head unit Hn is provided, and it is assumed that the notification section 75 notifies the user U that the bonding portion GL in one of the head units Hn is deteriorated. In this case, the head manufacturer can extend the lifetime of the liquid ejecting head 30 by replacing the head unit Hn in which deterioration of the bonding portion GL is detected.

What is claimed is:

1. A liquid ejecting head comprising:
a flow path that communicates with a nozzle configured to eject liquid;
an accommodating space;
a first bonding portion that partitions the flow path from the accommodating space; and
an outflow material that is accommodated in the accommodating space and that flows out into the flow path when the first bonding portion no longer partitions the flow path from the accommodating space.

2. The liquid ejecting head according to claim 1, further comprising:
a first flow path member that constitutes a first flow path, which is a part of the flow path;
a second flow path member that constitutes a second flow path, which is a part of the flow path; and
a second bonding portion that bonds the first flow path member and the second flow path member such that the first flow path and the second flow path are in liquid-tight communication, wherein
the first bonding portion and the second bonding portion are formed of the same type of adhesive.

3. The liquid ejecting head according to claim 2, wherein
a shortest distance from a portion of the first bonding portion that defines the flow path to a portion of the first bonding portion that defines the accommodating space is shorter than a shortest distance from a portion of the second bonding portion that defines the flow path to an end portion of the second bonding portion on a side opposite to the portion that defines the flow path.

4. The liquid ejecting head according to claim 1, further comprising:
a first flow path member that constitutes a first flow path, which is a part of the flow path;
a second flow path member that constitutes a second flow path, which is a part of the flow path; and
a second bonding portion that bonds the first flow path member and the second flow path member such that the first flow path and the second flow path are in liquid-tight communication, wherein
a liquid resistance of the first bonding portion is lower than a liquid resistance of the second bonding portion.

5. The liquid ejecting head according to claim 1, further comprising:
a filter disposed downstream of the accommodating space in the flow path, wherein
the outflow material contains powder having a size such that the powder does not pass through an opening of the filter.

6. The liquid ejecting head according to claim 5, wherein
an amount of the outflow material accommodated in the accommodating space is an amount such that the filter is occluded.

7. The liquid ejecting head according to claim 1, wherein
the outflow material contains a color material containing at least one of a dye and a pigment.

8. The liquid ejecting head according to claim 7, wherein
the outflow material contains two or more color materials having different colors.

9. The liquid ejecting head according to claim 1, wherein
the outflow material contains a phosphor that reacts with ultraviolet light to emit light when irradiated with the ultraviolet light.

10. A liquid ejecting head comprising:
a flow path that communicates with a nozzle that ejects liquid; and
a third bonding portion disposed in the flow path, wherein
the third bonding portion contains an outflow material that flows out into the flow path when the third bonding portion is eluted into liquid in the flow path.

11. A liquid ejecting apparatus comprising:
the liquid ejecting head according to claim 5 including
a first flow path member that constitutes a first flow path, which is a part of the flow path,
a second flow path member that constitutes a second flow path, which is a part of the flow path, and
a second bonding portion that bonds the first flow path member and the second flow path member such that the first flow path and the second flow path are in liquid-tight communication;
an acquisition section that acquires information regarding whether or not the filter is clogged with the outflow material; and
an estimation section that estimates a degree of deterioration of the second bonding portion based on the information acquired by the acquisition section.

12. A liquid ejecting apparatus comprising:
the liquid ejecting head according to claim 6 including
a first flow path member that constitutes a first flow path, which is a part of the flow path,
a second flow path member that constitutes a second flow path, which is a part of the flow path, and
a second bonding portion that bonds the first flow path member and the second flow path member such that the first flow path and the second flow path are in liquid-tight communication;
an acquisition section that acquires information regarding whether or not the filter is clogged with the outflow material; and
an estimation section that estimates a degree of deterioration of the second bonding portion based on the information acquired by the acquisition section.

13. The liquid ejecting apparatus according to claim 11, further comprising:
a notification section that issues a notification prompting replacement of the liquid ejecting head when the estimation section estimates that the second bonding portion is deteriorated.

14. A liquid ejecting apparatus comprising:
the liquid ejecting head according to claim 7 including
a first flow path member that constitutes a first flow path, which is a part of the flow path,
a second flow path member that constitutes a second flow path, which is a part of the flow path, and
a second bonding portion that bonds the first flow path member and the second flow path member such that the first flow path and the second flow path are in liquid-tight communication;
an acquisition section that acquires information regarding whether or not a color of liquid flowing in the flow path is abnormal; and
an estimation section that estimates a degree of deterioration of the second bonding portion based on the information acquired by the acquisition section.

15. A liquid ejecting apparatus comprising:
the liquid ejecting head according to claim 8 including
a first flow path member that constitutes a first flow path, which is a part of the flow path,
a second flow path member that constitutes a second flow path, which is a part of the flow path, and
a second bonding portion that bonds the first flow path member and the second flow path member such that the first flow path and the second flow path are in liquid-tight communication;
an acquisition section that acquires information regarding whether or not a color of liquid flowing in the flow path is abnormal; and
an estimation section that estimates a degree of deterioration of the second bonding portion based on the information acquired by the acquisition section.

16. The liquid ejecting apparatus according to claim 14, further comprising:
a notification section that issues a notification prompting replacement of the liquid ejecting head when the estimation section estimates that the second bonding portion is deteriorated.
